(19) United States
(12) Patent Application Publication
(10) Pub. No.: US 2024/0204921 A1
(43) Pub. Date: Jun. 20, 2024

(54) METHOD AND APPARATUS FOR PERIODICALLY TRANSMITTING AND RECEIVING DATA IN WIRELESS COMMUNICATION SYSTEM

(71) Applicant: SAMSUNG ELECTRONICS CO., LTD., Suwon-si (KR)

(72) Inventors: Sungjin PARK, Suwon-si (KR); Hyunseok RYU, Suwon-si (KR); Kyoungmin PARK, Suwon-si (KR); Sangkyu BAEK, Suwon-si (KR)

(21) Appl. No.: 18/543,465

(22) Filed: Dec. 18, 2023

(30) Foreign Application Priority Data
Dec. 20, 2022 (KR) 10-2022-0179222

(51) Int. Cl. H04L 1/1829; H04L 1/1812; H04L 1/1867

(52) U.S. Cl. CPC H04L 1/1854; H04L 1/1812; H04L 1/1887

(57) ABSTRACT

The disclosure relates to a 5G or 6G communication system for supporting a higher data transmission rate. Provided are a method and an apparatus for periodically transmitting and receiving data. The method of a terminal comprises: receiving, from a base station, a configuration on a CG; identifying, based on the configuration, a plurality of CG PUSCHs within a periodicity; identifying, based on an order of a CG PUSCH within the periodicity, a plurality of HARQ process IDs for the plurality of CG PUSCHs; and transmitting, to the base station, the plurality of CG PUSCHs within the periodicity based on the plurality of HARQ process IDs.

### CROSS-REFERENCE TO RELATED APPLICATIONS

This application is based on and claims priority under 35 U.S.C. § 119 to Korean Patent Application No. 10-2022-0179222, filed on Dec. 20, 2022, in the Korean Intellectual Property Office, the disclosure of which is herein incorporated by reference in its entirety.

### BACKGROUND

### 1. Field

The disclosure relates to a wireless communication system (or mobile communication system). More particularly, the disclosure relates to a grant-free (GF) data transmission method in a wireless communication system (or mobile communication system).

### 2. Description Of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A 5G communication system has been developed to provide various services, and a method of efficiently providing the services is needed according to provision of the various services. Accordingly, research on grant-free communication is being actively conducted.

The above information is presented as background information only to assist with an understanding of the disclosure. No determination has been made, and no assertion is made, as to whether any of the above might be applicable as prior art with regard to the disclosure.

### SUMMARY

Hereinafter, the disclosure describes embodiments for performing grant-free data transmission and reception efficiently using radio resources. Particularly, a downlink grant-free data transmission and reception method and an uplink grant-free data transmission and reception method are described.

In accordance with an embodiment of the disclosure, a method performed by a terminal is provided. The method comprises: receiving, from a base station, a configuration on a configured grant (CG); identifying a plurality of CG physical uplink shared channels (PUSCHs) within a periodicity based on the configuration; identifying a plurality of hybrid automatic repeat request (HARQ) process identities (IDs) for the plurality of CG PUSCHs based on an order of a CG PUSCH within the periodicity; and transmitting, to the base station, the plurality of CG PUSCHs within the periodicity according to the plurality of HARQ process IDs.

In accordance with another embodiment of the disclosure, a method performed by a base station is provided. The method comprises: transmitting, to a terminal, a configuration on a configured grant (CG); and receiving, from the terminal, a plurality of CG physical uplink shared channels (PUSCHs) within a periodicity according to a plurality of hybrid automatic repeat request (HARQ) process identities (IDs) based on the configuration, wherein the plurality of HARQ process IDs for the plurality of CG PUSCHs are based on an order of a CG PUSCH within the periodicity.

In accordance with an embodiment of the disclosure, a terminal is provided. The terminal comprises: a transceiver; and a controller coupled with the transceiver and configured to: receive, from a base station, a configuration on a configured grant (CG), identify a plurality of CG physical uplink shared channels (PUSCHs) within a periodicity based on the configuration, identify a plurality of hybrid automatic repeat request (HARQ) process identities (IDs) for the plurality of CG PUSCHs based on an order of a CG PUSCH within the periodicity, and transmit, to the base station, the plurality of CG PUSCHs within the periodicity according to the plurality of HARQ process IDs.

In accordance with an embodiment of the disclosure, a base station is provided. The base station comprises: a transceiver; and a controller coupled with the transceiver and configured to: transmit, to a terminal, a configuration on a configured grant (CG), and receive, from the terminal, a plurality of CG physical uplink shared channels (PUSCHs) within a periodicity according to a plurality of hybrid automatic repeat request (HARQ) process identities (IDs) based on the configuration, wherein the plurality of HARQ process IDs for the plurality of CG PUSCHs are based on an order of a CG PUSCH within the periodicity.

According to embodiments of the disclosure, radio resources can be efficiently used, and various services can be efficiently provided to a user according to a priority.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a transmission structure of time-frequency domains which are wireless resource areas of a 5G or NR system according to an embodiment of the present disclosure;

FIG. 2 illustrates an example of allocating data for eMBB, URLLC, and mMTC in time-frequency resource areas in the 5G or NR system according to an embodiment of the present disclosure;

FIG. 3 illustrates a grant-free transmission/reception operation according to an embodiment of the present disclosure;

FIG. 4 illustrates a semi-static HARQ-ACK codebook configuration method in the NR system according to an embodiment of the present disclosure;

FIG. 5 illustrates a dynamic HARQ-ACK codebook configuration method in the NR system according to an embodiment of the present disclosure;

FIG. 6 illustrates a process of transmitting HARQ-ACK for DL-SPS according to an embodiment of the present disclosure;

FIG. 7 illustrates a process in which a UE transmits semi-static HARQ-ACK codebook-based HARQ-ACK information for DCI indicating SPS PDSCHdeactivation;

FIG. 8 illustrates a method by which the UE determines a dynamic HARQ-ACK codebook for SPS PDSCH reception according to an embodiment of the present disclosure;

FIG. 9 illustrates periodic uplink data transmission resources according to an embodiment of the present disclosure;

FIG. 10 illustrates periodic uplink data repetitive transmission resources according to an embodiment of the present disclosure;

FIG. 11 illustrates the case in which different TBs are allocated to different CGPUSCH resources according to an embodiment of the present disclosure;

FIG. 12 illustrates a plurality of periodically transmitted CG PUSCH resources according to an embodiment of the present disclosure;

FIG. 13 illustrates a method of determining an HARQ process ID for a CG PUSCH of the UE according to an embodiment of the present disclosure;

FIG. 14 illustrates a structure of a UE capability according to embodiments of the present disclosure; and

FIG. 15 illustrates a structure of a BS capability according to embodiments of the present disclosure.

### DETAILED DESCRIPTION

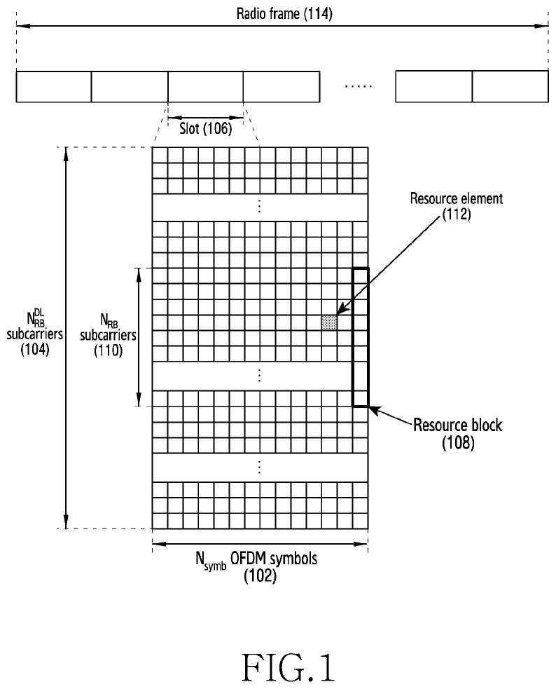

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services. In addition, as 5th generation communication systems, 5G or new radio (NR) communication standards are under development.

As a typical example of the broadband wireless communication system, a 5G or NR system employs an orthogonal frequency division multiplexing (OFDM) scheme in a downlink (DL) and an uplink (UL). More specifically, the 5G or NR system employs a cyclic-prefix OFDM (CP-OFDM) scheme in a downlink and employs, in addition to the CP-OFDM scheme, a discrete Fourier transform spreading (DFT-S-OFDM) scheme in an uplink. The uplink indicates a radio link through which a user equipment (UE) or a mobile station (MS) transmits data or control signals to a base station (BS) or (gNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

The 5G or NR system employs a hybrid automatic repeat request (HARQ) scheme in which, when decoding is unsuccessful at the initial transmission, the corresponding data is retransmitted in a physical layer. In the HARQ scheme, when a receiver fails to accurately decode data, the receiver transmits information (negative acknowledgement: NACK) informing a transmitter of the unsuccessful decoding and thus the transmitter may retransmit the corresponding data in the physical layer. The receiver may increase data reception performance by combining the data retransmitted by the transmitter with the data the decoding of which has previously failed. Also, when the receiver accurately decodes data, the receiver transmits information (acknowledgement: ACK) informing the transmitter of the successful decoding and thus the transmitter may transmit new data.

The NR system, which is a new 5G communication system, is designed to enable various services to be freely multiplexed in time and frequency resources. Accordingly, a waveform, a numerology, a reference signal, and the like may be dynamically or freely assigned according to the needs of a corresponding service. The types of services supported in the 5G or NR system may be categorized into enhanced mobile broadband (eMBB), massive machine type communications (mMTC), ultra-reliable and low-latency communications (URLLC), etc. eMBB is a service that aims at high-speed transmission of large-capacity data, mMTC is a service that aims at UE power minimization and multi-UE access, and URLLC is a service that aims at high reliability and low latency. Different requirements may be applied depending on the type of service applied to a UE.

In the disclosure, the respective terms are terms defined in consideration of their functions, and may be different according to users, intentions of the users, or customs. Therefore, the definitions of the terms should be made based on the contents throughout the specification. In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions.

In the disclosure, the conventional terms “physical channel” and “signal” may be interchangeably used with the term “data” or “control signal.” For example, a physical downlink shared channel (PDSCH) is a term referring to a physical channel over which data is transmitted, but in the disclosure, the PDSCH may be used to refer to data. That is, PDSCH transmission/reception may be understood as data transmission/reception.

In the disclosure, higher signaling (alternatively, may be interchangeably used with higher signal, higher layer signal, or higher layer signaling) means a signal transmission method in which a base station transmits a signal to a terminal by using a downlink data channel in a physical layer or a terminal transmits a signal to a base station by using an uplink data channel in a physical layer. The higher signaling may also be referred to as radio resource control (RRC) signaling or a media access control (MAC) control element (CE).

According to recent research on the 5G communication system, various schemes for scheduling communication with the UE have been discussed. Accordingly, an efficient scheduling and data transmission/reception method considering characteristics of the 5G communication system is required. Therefore, a method of providing each service in the same time interval according to a characteristic of the corresponding service in order to provide a plurality of services to a user and an apparatus using the same are needed in a communication system.

The UE may receive separate control information from the BS in order to transmit or receive data to or from the BS. However, in the case of a service type requiring periodically generated traffic or low latency, and/or high reliability, it may be possible to transmit or receive data without the separate control information. Such a transmission method is called a configured grant (or interchangeably used with grant-free or configured scheduled)-based data transmission method. A method of receiving or transmitting data after data transmission resources configured through control information are configured and relevant information is received may be a first signal transmission/reception type, and a method of transmitting or receiving data on the basis of pre-configured information without any control information may be a second signal transmission/reception type. For the second signal transmission/reception type, pre-configured resource areas periodically exist, and the areas have an uplink type 1 grant (UL type 1 grant) which is a method including a configuration of only an higher signal and an uplink type 2 grant (UL type 2 grant) which is a method including a configuration of a combination of a higher signal and an L1 signal (that is, downlink control information (DCI)) (or semi-persistent scheduling (SPS) or configured downlink assignment). In the case of the UL type 2 grant (or SPS), some pieces of information are determined by the higher signal, and whether to actually transmit data is determined by the L1 signal. The L1 signal may be largely divided into a signal indicating activation of resources configured through a higher layer and a signal indicating release of the activated resources.

An extended reality (XR) service is a service that requires a high data transmission rate like eMBB and also requires low latency time and high reliability like URLLC. Accordingly, XR traffic may include not only periodically generated data like the conventional voice but also aperiodically generated traffic. For example, when information on virtual space reality is transmitted and received in real time, event-based data may be generated and data transmission rate requirements according thereto may vary. Accordingly, an aperiodic data transmission/reception scheme reflecting the XR traffic characteristic may be needed.

The disclosure includes, when a DL SPS transmission period is aperiodic or smaller than 1 slot, a semi-static HARQ-ACK codebook and dynamic HARQ-ACK codebook determination method and an HARQ-ACK information transmission method corresponding thereto. Further, the disclosure includes a method of uplink (UL) CG (or configured uplink grants) transmission as well as DL SPS transmission. In addition, the disclosure includes a configuration method of supporting aperiodic transmission of the DL SPS and the UL CG.

FIG. 1 illustrates a transmission structure of time-frequency domains which are radio resource areas in the 5G or NR system according to an embodiment of the present disclosure.

Referring to FIG. 1, in the radio resource areas, the horizontal axis indicates a time domain and the vertical axis indicates a frequency domain. The minimum transmission unit in the time domain is an OFDM symbol, and Nsymb OFDM symbols 102 correspond to one slot 106. The length of a subframe may be defined as 1.0 ms, and a radio frame 114 may be defined as 10 ms. The minimum transmission unit in the frequency domain is a subcarrier, and a bandwidth of the entire system transmission band may include a total of NBW subcarriers 104. However, such detailed values may be variably applied according to a system.

A basic unit of the time-frequency resource areas is a resource element (RE) 112, and may be indicated by an OFDM symbol index and a subcarrier index. A resource block (RB) 108 may be defined as NRB consecutive subcarriers 110 in the frequency domain.

In general, the minimum transmission unit of data is an RB. In the 5G or NR system, in general, Nsymb=14, NRB=12, and NBW may be proportional to the bandwidth of the system transmission band. The data rate increases in proportion to the number of RBs scheduled to the UE. In the case of an FDD system in which the downlink and the uplink are divided and operated according to the frequency in the 5G or NR system, a downlink transmission bandwidth and an uplink transmission bandwidth may be different. A channel bandwidth refers to an RF bandwidth corresponding to a system transmission bandwidth. [Table 1] below shows the corresponding relation between a system transmission bandwidth defined in the LTE system that is 4th-generation wireless communication before the 5G or NR system and a channel bandwidth. For example, the LTE system having a channel bandwidth of 10 MHz has a transmission bandwidth of 50 RBs.

TABLE 1

| | | | | | | |
|---|---|---|---|---|---|---|
| Channel bandwidth | 1.4 | 3 | 5 | 10 | 15 | 20 |
| BW_{Channel} [MHz] | | | | | | |
| Transmission bandwidth | 6 | 15 | 25 | 50 | 75 | 100 |
| configuration N_{RB} | | | | | | |

In the 5G or NR system, a wider channel bandwidth than the channel bandwidth of LTE shown in [Table 1] may be adopted. [Table 2] shows the corresponding relation between a system transmission bandwidth of the 5G or NR system, and a channel bandwidth and subcarrier spacing (SCS).

TABLE 2

| | SCS | Channel bandwidth BW_{Channel} [MHz] | | | | | | | | | |
|---|---|---|---|---|---|---|---|---|---|---|---|
| | [kHz] | 5 | 10 | 15 | 20 | 25 | 40 | 50 | 60 | 80 | 100 |
| Maxi- | 15 | 25 | 52 | 79 | 106 | 133 | 216 | 270 | N.A. | N.A. | N.A |
| mum | 30 | 11 | 24 | 38 | 51 | 65 | 106 | 133 | 162 | 217 | 273 |
| Trans- | 60 | N.A. | 11 | 18 | 24 | 31 | 51 | 65 | 79 | 107 | 135 |
| mission | | | | | | | | | | | |
| band- | | | | | | | | | | | |
| width | | | | | | | | | | | |
| N_{RB} | | | | | | | | | | | |

In the 5G or NR system, scheduling information for downlink data or uplink data is transferred from the BS to the UE through downlink control information (DCI). The DCI is defined in various formats. Each format may indicate whether the DCI is scheduling information (UL grant) for uplink data or scheduling information (DL grant) for downlink data, whether the DCI is compact DCI having small size control information, whether the DCI applies spatial multiplexing using multiple antennas, and whether the DCI is DCI for controlling power. For example, DCI format 1_1 which is scheduling control information (DL grant) of downlink data may include one of pieces of the following control information:
Carrier indicator: indicates a frequency carrier through which transmission is performed;
DCI format indicator: indicates an indicator for identifying whether the corresponding DCI is for the downlink or the uplink;
Bandwidth part (hereinafter, referred to as a BWP) indicator: indicates a BWP in which transmission is performed;
Frequency domain resource allocation (FDRA): indicates RBs allocated to data transmission in the frequency domain Expressed resources are determined according to the system bandwidth and resource allocation scheme;
Time domain resource allocation (TDRA): indicates a slot and an OFDM symbol in which a data-related channel is to be transmitted;
VRB-to-PRB mapping: indicates a mapping scheme of a virtual RB (hereinafter, referred to as a VRB) index and a physical RB (hereinafter, referred to as a PRB) index;
Modulation and coding scheme (MCS): indicates a modulation scheme and a coding rate used for data transmission; That is, a coding rate value informing of a transport block size (TBS) and channel coding information along with information indicating quadrature phase shift keying (QPSK), 16 quadrature amplitude modulation (QAM), 64 QAM, or 256 QAM may be indicated;
Codeblock group (CBG) transmission information: indicates information on which CBG is transmitted when CBG retransmission is configured;
HARQ process number: indicates a process number of HARQ;
New data indicator (NDI): indicates initial HARQ transmission or HARQ retransmission;
Redundancy version (RV): indicates a redundancy version of HARQ;
Physical uplink control channel (PUCCH) resource indicator: indicates PUCCH resources for transmitting ACK/NACK information of downlink data;
PDSCH-to-HARQ feedback timing indicator: indicates a slot in which ACK/NACK information for downlink data is transmitted; and/or
Transmit power control (TPC) command for PUCCH: indicates a transmission power control command for a PUCCH which is an uplink control channel.

In the case of PUSCH transmission, time domain resource assignment may be delivered by information on a slot in which the PUSCH is transmitted, a start OFDM symbol location S in the corresponding slot, and the number L of OFDM symbols to which the PUSCH is mapped. S may be a relative location from start of the slot, L may be the number of successive OFDM symbols, and S and L may be determined from a start and length indicator value (SLIV) defined below as shown in [Table 3].

TABLE 3

```
If (L-1) ≤ 7 then
  SLIV = 14*(L-1)+S
else
  SLIV= 14*(14-L+1)+(14-1-S)
where 0 < L ≤ 14-S
```

In the 5G or NR system, in general, a table including an SLIV value, a PUSCH mapping type, and information on a slot for transmitting the PUSCH in one row may be configured through an RRC configuration. Thereafter, in the time domain resource assignment of the DCI, the BS may transmit, to the UE, information on the SLIV value, the PUSCH mapping type, and the slot in which the PUSCH is transmitted by indicating an index value in the configured table. Such a method is also applied to the PDSCH.

Specifically, when the BS indicates a time resource allocation field index m included in DCI for scheduling the PDSCH to the UE, it may inform of a combination of DRMS Type A position information corresponding to m+1, PDSCH mapping type information, a slot index K0, a data resource start symbol S, and a data resource allocation length L in the table indicating time domain resource allocation information. For example, [Table 4] below is a table including normal cyclic prefix-based PDSCH time domain resource allocation information.

TABLE 4

| | | PDSCH | | | |
|---|---|---|---|---|---|
| Row | | mapping | | | |
| index | dmrs-TypeA-Position | type | K₀ | S | L |
| 1 | 2 | Type A | 0 | 2 | 12 |
| | 3 | Type A | 0 | 3 | 11 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2, 3 | Type B | 0 | 5 | 7 |
| 9 | 2, 3 | Type B | 0 | 5 | 2 |
| 10 | 2, 3 | Type B | 0 | 9 | 2 |
| 11 | 2, 3 | Type B | 0 | 12 | 2 |
| 12 | 2, 3 | Type A | 0 | 1 | 13 |
| 13 | 2, 3 | Type A | 0 | 1 | 6 |
| 14 | 2, 3 | Type A | 0 | 2 | 4 |
| 15 | 2, 3 | Type B | 0 | 4 | 7 |
| 16 | 2, 3 | Type B | 0 | 8 | 4 |

In [Table 4], dmrs-typeA-Position is a field informing of a symbol location at which the DMRS is transmitted in one slot indicated by a system information block (SIB) which is one of UE-common control information. An available value of the corresponding field is 2 or 3. When a total number of symbols included in one slot is 14 and a first symbol index is 0, 2 refers to a third symbol and 3 refers to a fourth symbol. In [Table 4], the PDSCH mapping type is information informing of a location of the DMRS in the scheduled data resource area. When the PDSCH mapping type is A, the DMRS may be always transmitted and received at the symbol location determined by the dmrs-typeA-Position regardless of allocated data time domain resources. When the PDSCH mapping type is B, the DMRS may be always transmitted and received in a first symbol in the allocated data time domain resources. In other words, the PDSCH mapping type B may not use dmrs-typeA-Position information.

In [Table 4], K0 denotes an offset of a slot index to which the physical downlink control channel (PDCCH) for transmitting DCI belongs and a slot index to which the PDSCH scheduled by the corresponding DCI or the PUSCH belongs. For example, when the slot index of the PDCCH is n, a slot index of the PDSCH scheduled by the DCI of the PDCCH or the PUSCH is n+K0. In [Table 4], S denotes a start symbol index of the data time domain resources in one slot. A range of an available S value is from 0 to 13 on the basis of a normal cyclic prefix. In [Table 4], L denotes a data time domain resource interval length in one slot. A range of an available L value is from 1 to 14.

In the 5G or NR system, a type A and a type B are defined as the PDSCH mapping type. In the PDSCH mapping type A, a first OFDM symbol of the DMRS OFDM symbols may be located in a second or a third OFDM symbol of the slot. In the PUSCH mapping type B, a first OFDM symbol of the DMSR OFDM symbols may be located in a first OFDM symbol of the time domain resources allocated through PUSCH transmission. The method of allocating PUSCH time domain resources can be equally applied to PDSCH time domain resource allocation.

DCI may be transmitted through a PDCCH (hereinafter, interchangeably used with control information) which is a downlink physical control channel via a channel coding and modulation process. In General, the DCI is scrambled by a specific radio network temporary identifier (RNTI) (or a UE identifier), independently for each UE, a cyclic redundancy check (CRC) is added, and channel coding is performed, whereby each independent PDCCH is configured and transmitted. The PDCCH is mapped to a control resource set (CORESET) configured in the UE and transmitted.

Downlink data may be transmitted through a PDSCH which is a physical channel for transmitting downlink data. The PDSCH may be transmitted after the control channel transmission interval, and the detailed mapping location in the frequency region and scheduling information such as the modulation scheme are determined on the basis of the DCI transmitted through the PDCCH.

Via the MCS of the control information included in the DCI, the BS may report the modulation scheme applied to a PDSCH to be transmitted to the UE and the size (transport block size (TBS)) of data to be transmitted. In an embodiment, the MCS may be configured by 5 bits or bits larger than or smaller than 5 bits. The TBS corresponds to the size before channel coding for error correction is applied to the data (TB) to be transmitted by the BS.

In the disclosure, the transport block (TB) may include a medium access control (MAC) header, a MAC CE, one or more MAC service data units (SDUs), and padding bits. Alternatively, the BS may indicate the unit of data from the MAC layer to the physical layer or a MAC protocol data unit (PDU).

The modulation scheme supported by the 5G or LTE system includes quadrature phase shift keying (QPSK), 16 quadrature amplitude modulation (QAM), 64 QAM, and 256 QAM. Respective modulation orders (Qm) correspond to 2, 4, 6, and 8, respectively. That is, 2 bits may be transmitted per symbol in the QPSK modulation, 4 bits may be transmitted per symbol in the 16 QAM modulation, 6 bits may be transmitted per symbol in the 64 QAM modulation, and 8 bits may be transmitted per symbol in the 256 QAM modulation.

When the PDSCH is scheduled by the DCI, HARQ-ACK information indicating whether the PDSCH is successfully decoded or the decoding fails is transmitted from the UE to the BS through the PUCCH. The HARQ-ACK information is transmitted in a slot indicated by a PDSCH-to-HARQ feedback timing indicator included in the DCI for scheduling the PDSCH, and values mapped to PDSCH-to-HARQ feedback timing indicators of 1 to 3 bits are configured by a higher-layer signal as shown in [Table 5]. When the PDSCH-to-HARQ feedback timing indicator indicates k, the UE may transmit HARQ-ACK information in a slot after k slots from a slot n in which the PDSCH is transmitted, that is, in a slot n+k.

TABLE 5

| PDSCH-to-HARQ_feedback timing indicator | | | |
|---|---|---|---|
| 1 bit | 2 bits | 3 bits | Number of slots k |
| “0” | “00” | “000” | 1^{st} value provided by |
| | | | dl-DataToUL-ACK |
| “1” | “01” | “001” | 2^{nd} value provided by |
| | | | dl-DataToUL-ACK |
| | “10” | “010” | 3^{rd} value provided by |
| | | | dl-DataToUL-ACK |
| | “11” | “011” | 4^{th} value provided by |
| | | | dl-DataToUL-ACK |
| | | “100” | 5^{th} value provided by |
| | | | dl-DataToUL-ACK |
| | | “101” | 6^{th} value provided by |
| | | | dl-DataToUL-ACK |
| | | “110” | 7^{th} value provided by |
| | | | dl-DataToUL-ACK |
| | | “111” | 8^{th} value provided by |
| | | | dl-DataToUL-ACK |

When the PDSCH-to-HARQ feedback timing indicator is not included in DCI format 1_1 for scheduling the PDSCH, the UE may transmit HARQ-ACK information in a slot n+k according to the value of k configured through higher-layer signaling. When transmitting the HARQ-ACK information through the PUCCH, the UE may transmit the HARQ-ACK information to the BS through PUCCH resources determined on the basis of a PUCCH resource indicator included in the DCI for scheduling the PDSCH. At this time, an ID of the PUCCH resources mapped to the PUCCH resource indicator may be configured through higher-layer signaling.

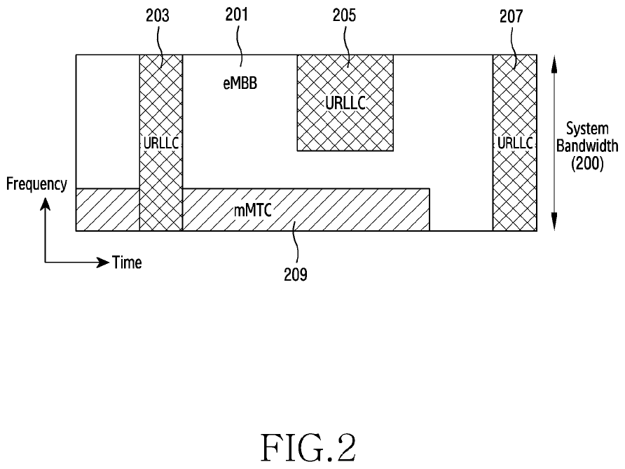

FIG. 2 illustrates an example of allocating data for eMBB, URLLC, and mMTC in time-frequency resource areas in the 5G or NR system according to an embodiment of the present disclosure.

Referring to FIG. 2, the data for eMBB, URLLC, and mMTC may be allocated to an entire system frequency band 200. When URLLC data 203, 205, and 207 are generated and are required to be transmitted while eMBB data 201 and mMTC data 209 are allocated to specific frequency bands and transmitted, the transmitter may empty the part to which the eMBB data 201 and the mMTC data 209 have been already allocated or transmit the URLLC data 203, 205, and 207 without transmission of the data. Among the services, URLLC needs to reduce a delay time, and thus URLLC data may be allocated to and transmitted in a part of resources to which eMBB or mMTC data is allocated. When the URLLC data is additionally allocated to and transmitted in resources to which the eMBB data has been allocated, the eMBB data may not be transmitted in duplicate frequency-time resources, and accordingly, the transmission performance of the eMBB data may be reduced. That is, the eMBB data transmission may fail due to URLLC allocation.

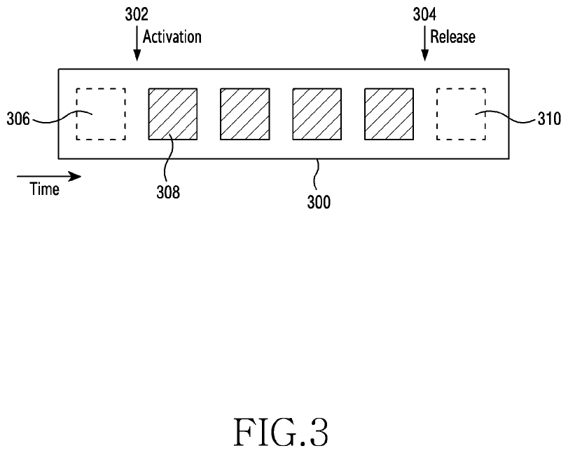

FIG. 3 illustrates a grant-free transmission and reception operation according to an embodiment of the present disclosure.

The UE have a first signal transmission/reception type of receiving downlink data from the BS according to information configured only through a higher signal and a second signal transmission/reception type of receiving downlink data according to transmission configuration information indicated by a higher signal and an L1 signal. The disclosure mainly describes a UE operation method of the second signal transmission/reception type. In the disclosure, SPS which is the second signal type for receiving downlink data means downlink grant-free-based PDSCH transmission. In DL SPS, the UE may receive the grant-free-based PDSCH transmission through additional configuration information indicated by the higher signal configuration and DCI.

DL SPS means downlink semi-persistent scheduling, and is a method by which the BS periodically transmits and receives downlink data information to and from the UE on the basis of information configured through higher signaling without specific downlink control information scheduling. It may be applied to a voice over internet protocol (VOIP) or a periodically generated traffic situation. Alternatively, a resource configuration for DL SPS may be periodic but actually generated data may be aperiodic. In such a case, the UE does not know whether actual data is generated in the periodically configured resources, and thus two types of operations below can be performed.
Method 3-1: for the periodically configured DL SPS resource area, the UE transmits HARQ-ACK information for an uplink resource area corresponding to the corresponding resource area to the BS, based on the demodulation/decoding result of received data.
Method 3-2: when the UE successfully detects at least a DMRS or a signal for data for the periodically configured DL SPS resource area, the UE transmits HARQ-ACK information for an uplink resource area corresponding to the corresponding resource area for a demodulation/decoding result of the received data to the BS.
Method 3-3: when the UE succeeds in the demodulation/decoding (that is, ACK) for the periodically configured DL SPS resource area, the UE transmits HARQ-ACK information for an uplink resource area corresponding to the corresponding resource area for a demodulation/decoding result of the received data to the BS.

In Method 3-1, the UE always transmits HARQ-ACK information to the uplink resource area corresponding to the corresponding DL SPS resource area even though the BS does not actually transmit downlink data for the DL SPS resource area. In method 3-2, the UE can transmit HARQ-ACK information if the UE know whether data is transmitted/received like in a situation in which the UE successively detects a DMRS or a CRC since the UE does not know when the BS transmits data to the DL SPS resource area. In method 3-3, HARQ-ACK information is transmitted to the uplink resource area corresponding to the corresponding DP SPS resource area only when the UE successively demodulates/decodes data.

Among the above-described methods, the UE is always able to support only one method or support two or more methods. One of the methods can be selected through the 3GPP standard or a higher signal. For example, method 3-1 is indicated through a higher signal, the UE can transmit HARQ-ACK information for the corresponding DL SPS on the basis of method 3-1. Alternatively, one method can be selected according to DL SPS higher configuration information. For example, the UE can apply method 3-1 when a transmission period is n slots or longer in DL SPS higher configuration information, and apply method 3-3 in the opposite case. In this embodiment, the transmission period is described as an example, but an applied MCS table, DMRS configuration information, or resource configuration information can be sufficiently used.

The UE receives downlink data in the downlink resource area configured through higher-layer signaling. The downlink resource area configured through higher-layer signaling can be activated or released through L1 signaling.

FIG. 3 illustrates an operation for DL SPS. The UE configures the following DL SPS configuration information from a higher-layer signal:
Periodicity: DL SPS transmission period;
nrofHARQ-Processes: the number of HARQ processes configured for the DL SPS;
n1PUCCH-AN: HARQ resource configuration information for DL SPS; and/or
mcs-Table: MCS table configuration information applied to DL SPS.

In the disclosure, all pieces of the DL SPS configuration information can be configured for each Pcell or each Scell and also configured for each bandwidth part (BWP). Further, one or more DL SPSs can be configured for each specific cell or BWP.

In FIG. 3, the UE determines grant-free transmission/reception configuration information 300 through reception of a higher-layer signal for DL SPS. In the DL SPS, data can be transmitted and received for a resource area 308 configured after the reception 302 of DCI indicating activation and data can be transmitted and received for an entire resource area 306 before reception of the corresponding DCI. Further, for a resource area 310 after reception 304 of DCI indicating release, the UE cannot receive data.

When all of the two conditions below are satisfied for SPS scheduling activation or release, the UE verifies the DL SPS assignment PDCCH:
Condition 1: a CRC bit of a DCI format transmitted in the PDCCH is scrambled by a configured scheduling (CS)-RNTI configured through higher-layer signaling; and
Condition 2: an NDI field for an activated transport block is configured as 0.

When some of the fields included in DCI formats transmitted through the DL SPS assignment PDCCH are the same as those shown in [Table 6] or [Table 7], the UE determines that information within the DCI format is valid activation or valid release of the DL SPS. For example, when the UE detects the DCI format including the information shown in [Table 5], the UE determines that the DL SPS is activated. In another example, when the UE detects the DCI format including the information shown in [Table 7], the UE determines that the DL SPS is released.

When some of the fields included in the DCI formats transmitted through the DL SPS assignment PDCCH are not the same as those shown in [Table 6] (special field configuration information for activating DL SPS) or [Table 7] (special field configuration information for releasing DL SPS), the UE determines that the DCI format is detected by a non-matching CRC.

TABLE 6

| | DCI format 1_0 | DCI format 1_1 |
|---|---|---|
| HARQ process number | set to all “0”s | set to all “0”s |
| Redundancy version | set to “00” | For the enabled transport |
| | | block: set to “00” |

TABLE 7

| | DCI format 1_0 |
|---|---|
| HARQ process number | set to all “0”s |
| Redundancy version | set to “00” |
| Modulation and coding scheme | set to all “1”s |
| Resource block assignment | set to all “1”s |

When the UE receives the PDSCH without reception of the PDCCH or receives the PDCCH indicating SPS PDSCH release, the UE generates an HARQ-ACK information bit corresponding thereto. Further, in at least Rel-15 NR, the UE does not expect transmission of HARQ-ACK information(s) for reception of two or more SPS PDSCHs in one PUCCH resource. In other words, in at least Rel-15 NR, the UE includes only HARQ-ACK information for reception of one SPS PDSCH in one PUCCH resource.

DL SPS may be also configured in a primary cell (PCell) and a secondary cell (SCell). Parameters which can be configured through DL SPS higher-layer signaling may be described below:
Periodicity: DL SPS transmission period;
nrofHARQ-processes: the number of HARQ processes which can be configured for DL SPS; and/or
n1PUCCH-AN: PUCCH HARQ resources for DL SPS, wherein the BS configures resources by PUCCH format 0 or 1.

[Table 6] and [Table 7] described above may be fields in which only one DL SPS can be configured for each cell and each BWP. In a situation in which a plurality of DL SPSs are configured for each cell and each BWP, a DCI field for activating (or releasing) each DL SPS resource may vary. The disclosure provides a method of solving such a situation.

In the disclosure, not all DCI formats described in [Table 6] and [Table 7] are used for activating or releasing DL SPS resources. For example, DCI format 1_0 and DCI format 1_1 used to schedule the PDSCH may be used for activating DL SPS resources. For example, DCI format 1_0 used for scheduling the PDSCH may be used to release DL SPS resources.

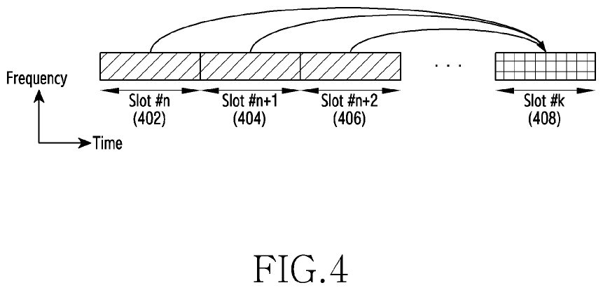

FIG. 4 illustrates a semi-static HARQ-ACK codebook configuration method in the NR system according to an embodiment of the present disclosure.

In a situation in which the number of HARQ-ACK PUCCHs which can be transmitted by the UE within one slot is limited to one, when the UE receives a semi-static HARQ-ACK codebook higher configuration, the UE may report HARQ-ACK information for PDSCH reception or SPS PDSCH release through an HARQ-ACK codebook in a slot indicated by a value of a PDSCH-to-HARQ_feedback timing indicator in DCI format 1_0 or DCI format 1_1. The UE reports, as NACK, an HARQ-ACK information bit value within the HARQ-ACK codebook in a slot which is not indicated by the PDSCH-to-HARQ feedback timing indicator field in DCI format 1_0 or DCI format 1_1. If the UE reports only HARQ-ACK information for one SPS PDSCH release or one PDSCH reception in the cases of MA,c for reception of candidate PDSCHs and the report is scheduled by DCI format 1_0 including information indicating 1 by a counter DAI field in the Pcell, the UE determines one HARQ-ACK codebook for the corresponding SPS PDSCH release or the corresponding PDSCH reception.

In other cases, an HARQ-ACK codebook determination method follows the following method.

When a set of PDSCH reception candidates in a serving cell c is MA,c, MA,c may be obtained through the following steps of [pseudo-code 1] as shown in [Table 8].

TABLE 8
[pseudo-code 1 starts]
- Step 1: initialize j to 0 and MA,c to a null set k which is an HARQ-
ACK transmission timing index is initialized to 0.
- Step 2: configures R as a set of rows in a table including information
on a slot to which the PDSCH is mapped, start symbol information, the
number of symbols, or length information. When a mapping symbol of
an available PDSCH indicated by each value of R is configured as an UL
symbol according to the configured DL and UL configuration, the
corresponding row is deleted from R.
- Step 3-1: the UE may receive one PDSCH for unicast in one slot, and
one PDSCH is added to a set of MA,c if R is not a null set.
- Step 3-2: when the UE can receive one or more PDSCHs for unicast in
one slot, the number of PDSCHs which can be allocated to different
symbols is counted in the calculated R and the corresponding number is
added to MA,c.
- Step 4: increases k by 1 and start from step 2 again.
[pseudo-code 1 ends]

In a description of pseudo-code 1 by way of example of FIG. 4, all slot candidates for PDSCH-to-HARQ-ACK timing at which slot #k 408 can be indicated are considered to perform HARQ-ACK PUCCH transmission in slot #k 408. In FIG. 4, it is assumed that HARQ-ACK transmission is possible in slot #k 408 by a PDSCH-to-HARQ-ACK timing combination allowed only for PDSCHs scheduled in slot #n 402, slot #n+1 404, and slot #n 406. The maximum number of PDSCHs which can be scheduled for each slot is calculated in consideration of time domain resource configuration information of PDSCHs which can be scheduled in the slots 402, 404, and 406 and information indicating whether a symbol within the slot is for downlink or uplink. For example, when the maximum number of PDSCHs which can be scheduled in the slot 402 is 2, the maximum number of PDSCHs which can be scheduled in the slot 404 is 3, and the maximum number of PDSCHs which can be scheduled in the slot 406 is 2, the maximum number of PDSCHs included in an HARQ-ACK codebook transmitted in the slot 408 is 7. This is called cardinality of the HARQ-ACK codebook.

In a specific slot, step 3-2 is described through [Table 9] (default PDSCH time domain resource allocation A for normal CP) below.

TABLE 9

| Row | dmrs-TypeA- | PDSCH | | | | | |
|---|---|---|---|---|---|---|---|
| index | Position | mapping type | K₀ | S | L | Ending | Order |
| 1 | 2 | Type A | 0 | 2 | 12 | 13 | 1x |
| | 3 | Type A | 0 | 3 | 11 | 13 | 1x |
| 2 | 2 | Type A | 0 | 2 | 10 | 11 | 1x |
| | 3 | Type A | 0 | 3 | 9 | 11 | 1x |
| 3 | 2 | Type A | 0 | 2 | 9 | 10 | 1x |
| | 3 | Type A | 0 | 3 | 8 | 10 | 1x |
| 4 | 2 | Type A | 0 | 2 | 7 | 8 | 1x |
| | 3 | Type A | 0 | 3 | 6 | 8 | 1x |
| 5 | 2 | Type A | 0 | 2 | 5 | 6 | 1x |
| | 3 | Type A | 0 | 3 | 4 | 6 | 1x |
| 6 | 2 | Type B | 0 | 9 | 4 | 12 | 2x |
| | 3 | Type B | 0 | 10 | 4 | 13 | 3 |
| 7 | 2 | Type B | 0 | 4 | 4 | 7 | 1x |
| | 3 | Type B | 0 | 6 | 4 | 9 | 2 |
| 8 | 2, 3 | Type B | 0 | 5 | 7 | 11 | 1x |
| 9 | 2, 3 | Type B | 0 | 5 | 2 | 6 | 1x |
| 10 | 2, 3 | Type B | 0 | 9 | 2 | 10 | 2x |
| 11 | 2, 3 | Type B | 0 | 12 | 2 | 13 | 3x |
| 12 | 2, 3 | Type A | 0 | 1 | 13 | 13 | 1x |
| 13 | 2, 3 | Type A | 0 | 1 | 6 | 6 | 1x |
| 14 | 2, 3 | Type A | 0 | 2 | 4 | 5 | 1 |
| 15 | 2, 3 | Type B | 0 | 4 | 7 | 10 | 1x |
| 16 | 2, 3 | Type B | 0 | 8 | 4 | 11 | 2x |

[Table 9] is a time resource allocation table in which the UE operates by default before receiving allocation of time resources through a separate RRC signal. For reference, a PDSCH time resource allocation value is determined by dmrs-TypeA-Position which is a UE-common RRC signal in addition to an indication of a row index value through separate RRC In [Table 9] above, an encoding column and an order column are separately added for convenience of description, and they may not be actually exist. The ending column means an end symbol of the scheduled PDSCH, and the order column means a code location value located within a specific codebook in a semi-static HARQ-ACK codebook. The corresponding table is applied to time resource allocation applied in DCI format 1_0 in the common-search area of the PDCCH.

The UE performs the following steps in order to determine the HARQ-ACK codebook by calculating the maximum number of PDSCHs that do not overlap within a specific slot.
Step 1: search for a PDSCH allocation value first ending within a slot among all rows in the PDSCH time resource allocation table. In corresponding [Table 9], 14 of a row index first ends. This is expressed as 1 in the order column. Other row indexes which overlap with the corresponding order index 14 in at least one symbol are expressed as 1x in the order column.
Step 2: search for a PDSCH allocation value which first ends in the remaining row indexes which are not expressed in the order column. In [Table 9], the PDSCH allocation value corresponds to a row having a row index of 7 and a dmrs-TypeA-Position value of 3. Other row indexes which overlap with the corresponding order index in at least one symbol are expressed as 2× in the order column.
Step 3: increase and express an order value by repeating step 2. For example, a PDSCH allocation value which first ends in row indexes which are not expressed in the order column of [Table 9] is searched for. In [Table 9], the PDSCH allocation value corresponds to a row having a row index of 6 and a dmrs-TypeA-Position value of 3. Other row indexes which overlap with the corresponding order index in at least one symbol are expressed as 3× in the order column.
Step 4: end the process when all row indexes are expressed in the order. The size of the corresponding order is the maximum number of PDSCHs which can be scheduled in the corresponding slot without time overlapping. Scheduling having no time overlapping means that different PDSCHs are scheduled by TDM.

In the order column of [Table 9], a maximum value of order means the size of the HARQ-ACK codebook of the corresponding slot, and the order value means an HARQ-ACK codebook point at which an HARQ-ACK feedback bit for the corresponding scheduled PDSCH is located. For example, a row index 16 in [Table 9] means a second code location in a semi-static HARQ-ACK codebook having the size of 3. When a set of occasions for candidates PDSCH receptions in the serving cell c is MA,c, the UE transmitting HARQ-ACK feedback may calculate MA,c through the steps of [pseudo-code 1] or [pseudo-code 2]. MA,c may be used to determine the number of HARQ-ACK bits which the UE may transmit. Specifically, the HARQ-ACK codebook may be configured using cardinality of the MA,c set.

In another example, matters which may be considered to determine the semi-static HARQ-ACK codebook (or type 1 HARQ-ACK codebook) are described below [Table 10].

TABLE 10

| a) | on a set of slot timing values K₁ associated with the active UL BWP | |
|---|---|---|
| | i)) | If the UE is configured to monitor PDCCH for DCI format |

1_0 and is not configured to monitor PDCCH for DCI format 1_1 on
serving cell c, K₁ is provided by the slot timing values {1, 2, 3, 4, 5, 6,
7, 8} for DCI format 1_0

| | |
|---|---|
| ii) | If the UE is configured to monitor PDCCH for DCI |

format 1_1 for serving cell c, K₁ is provided by dl-DataToUL-ACK for
DCI format 1_1

| | |
|---|---|
| b) | on a set of row indexes R of a table that is provided either by a first |

set of row indexes of a table that is provided by PDSCH-
TimeDomainResourceAllocationList in PDSCH-ConfigCommon or by
Default PDSCH time domain resource allocation A [6, TS 38.214], or by
the union of the first set of row indexes and a second set of row indexes,
if provided by PDSCH-TimeDomainResourceAllocationList in PDSCH-
Config, associated with the active DL BWP and defining respective sets
of slot offsets Kₒ, start and length indicators SLIV, and PDSCH
mapping types for PDSCH reception as described in [6, TS 38.214]
c) on the ratio 2^{^{μ}}^{_{DL}}⁻^{^{μ}}^{_{UL}} between the downlink SCS configuration μ_{DL}
and the uplink SCS configuration provided by μ_{UL} subcarrierSpacing in
BWP-Downlink and BWP-Uplink for the active DL BWP and the active
UL BWP, respectively

| | |
|---|---|
| d) | if provided, on TDD-UL-DL-ConfigurationCommon and TDD- |

UL-DL-ConfigDedicated as described in Subclause 11.1.

In another example, pseudo-code for determining the HARQ-ACK codebook may be described below [Table 11].

TABLE 11

```
[pseudo-code 2 starts]
For the set of slot timing values K₁, the UE determines a set of M_{A,C}
occasions for candidate PDSCH receptions or SPS PDSCH releases
according to the following pseudo-code. A location in the Type-1 HARQ-
ACK codebook for HARQ-ACK information corresponding to a SPS PDSCH
release is same as for a corresponding SPS PDSCH reception.
Set j=O - index of occasion for candidate PDSCH reception or SPS
PDSCH release.
Set B=Ø.
Set M_{A,C} = Ø.
Set c(K₁) to the cardinality of set K₁.
Set k =0 - index of slot timing values K_{1,k}, in descending order of the slot
timing values, in set K₁ for serving cell.
while k<c(K₁)
              if mod(n_{U}-K_{1,k}+1, max(2^{μ}^{_{UI}}^{-μ}^{_{DL}}, 1))=0
Set n_{D}=O - index of a DL slot within an UL slot
while n_{D}<max(2^{μ}^{_{DL}}^{-μ}^{_{UL}},1)
      Set R to the set of rows
      Set c(R) to the cardinality of R
      Set r=0 - index of row in set R
      if slot n_{U} starts at a same time as or after a slot for an active DL
BWP change on serving cell c or an active UL BWP change on the PCell and
slot └(n_{U}-K_{1,k})*2^{μ}^{_{DL}}^{-μ}^{_{UL}}┘ +n_{D} is before the slot for the active DL BWP
change on serving cell c or the active UL BWP change on the PCell
              continue;
      else
              while r<c(R)
                    if the UE is provided TDD-UL-DL-
ConfigurationCommon orTDD-UL-DL-ConfigDedicated and, for each slot
from slot └(n_{U}-K_{1,k})*2^{μ}^{_{DL}}^{-μ}^{_{UL}}┘ +n_{D}-N_{PDSCH}^{repeat}+1 to slot
└(n_{U}-K_{1,k})*2^{μ}^{_{DL}}^{-μ}^{_{UL}}┘ +n_{D}, at least one symbol of the PDSCH time
resource derived by row r is configured as UL where K_{1,k} is the k-th slot
timing value in set K₁,
                              R=R/r;
                        end if
                        r=r+1;
                end while
                if the UE does not indicate a capability to receive more
than one unicast PDSCH per slot and R≠ Ø,
                        M_{A,c} =M_{A,c} ∪j;
                        j=j+1;
                        The UE does not expect to receive SPS PDSCH
release and unicast PDSCH in a same slot;
                else
                        Set c(R) to the cardinality of R
                        Set m to the smallest last OFDM symbol index,
as determined by the SLIV, among all rows of R
                        while R ≠ Ø
                              Set r=0
                        while r<c(R)
                              if S≤m for start OFDM symbol
index S for row r
                                    b_{r,k,n}_{_{D}} =j; - index of occasion
for candidate PDSCH reception or SPS PDSCH release associated with row
r
                                    R=R/r;
                                    B=B∪b_{r,k,n}_{_{D}};
                                    end if
                              r=r+1;
                              end while
                              M_{A,c}=M_{A,c} ∪j
                              j-j+1;
                              Set m to the smallest last OFDM symbol
index among all rows of R;
                              end while
                        end if
                  end if
                  n_{D}=n_{D}+1;
          end while
  end if
  k−k+1;
end while
[pseudo-code 2 ends]
```

In [pseudo-code 2], the location of the HARQ-ACK codebook including HARQ-ACK information for DCI indicating DL SPS release is based on the location at which the DL SPS PDSCH is received. For example, when a start symbol of transmission of the DL SPS PDSCH is a fourth OFDM symbol based on the slot and the length thereof is 5 symbols, it is assumed that HARQ-ACK information including DL SPS release indicating the release of the corresponding SPS starts from the fourth OFDM symbol of the slot in which the DL SPS release is transmitted and a PDSCH having the length of 5 symbols is mapped and HARQ-ACK information corresponding thereto is determined through a PDSCH-to-HACK timing indicator and a PUSCH resource indicator included in control information indicating DL SPS release. In another example, when a start symbol of transmission of the DL SPS PDSCH is a fourth OFDM symbol based on the slot and the length thereof is 5 symbols, it is assumed that HARQ-ACK information including DL SPS release indicating the release of the corresponding SPS starts from the fourth OFDM symbol of the slot indicated by time domain resource allocation (TDRA) of DCI that is the DL SPS release and a PDSCH having the length of 5 symbols is mapped and HARQ-ACK information corresponding thereto is determined through a PDSCH-to-ACK timing indicator and a PUSCH resource indicator included in control information indicating DL SPS release.

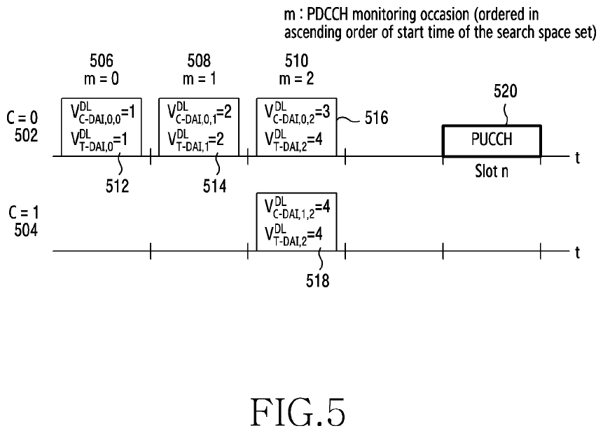

FIG. 5 illustrates a dynamic HARQ-ACK codebook configuration method in the NR system according an embodiment of the present disclosure.

The UE transmits HARQ-ACK information transmitted within one PUCCH in corresponding slot n on the basis of a PDSCH-to-HARQ feedback timing value for PUCCH transmission of HARQ-ACK information in slot n for PDSCH reception or SPS PDSCH release and K0 that is transmission slot location information of the PDSCH scheduled in DCI format 1_0 or 1_1. Specifically, for the HARQ-ACK information transmission, the UE determines an HARQ-ACK codebook of the PUCCH transmitted in the slot determined by the PDSCH-to-HARQ feedback timing and K0 on the basis of DAI included in the DCI indicating the PDSCH or SPS PDSCH release.

The DAI includes counter DAI and total DAI. The counter DAI is information informing of the location of HARQ-ACK information corresponding to the PDSCH scheduled in DCI format 1_0 or DCI format 1_1 within the HARQ-ACK codebook. Specifically, a value of the counter DAI within DCI format 1_0 or 1_1 indicates an accumulated value of PDSCH reception or SPS PDSCH release scheduled by DCI format 1_0 or DCI format 1_1 in a specific cell c. The accumulated value is configured on the basis of PDCCH monitoring occasion in which the scheduled DCI exists and the serving cell.

The total DAI is a value informing the size of the HARQ-ACK codebook. Specifically, a value of the total DAI means a total number of PDSCH or SPS PDSCH releases scheduled before a time point at which the DCI is scheduled. The total DAI is a parameter used when HARQ-ACK information in the serving cell c includes HARQ-ACK information for the PDSCH scheduled in another cell including the serving cell c in carrier aggregation (CA). In other words, in a system operated by one cell, there is no total DAI parameter.

An example of the operation for the DAI is illustrated in FIG. 5. FIG. 5 illustrates a change in values of counter DAI (C-DAI) and total DAI (T-DAI) indicated by DCI found for each PDCCH monitoring occasion configured for each carrier when the UE transmits an HARQ-ACK codebook selected on the basis of DAI in an nth slot of carrier 0 502 to a PUCCH 520 in a situation in which two carriers are configured. First, DCI found in m=0 506 indicates a value 512 of 1 by each of C-DAI and T-DAI. DCI found in m=1508 indicates a value 514 of 2 by C-DAI and T-DAI. DCI found in carrier 0 502 (c=0) of m=2 510 indicates a value 516 of 3 by C-DAI and T-DAI. DCI found in carrier 1 504 (c=1) of m=2 510 indicates a value 516 of 4 by C-DAI and T-DAI At this time, when carriers 0 and 1 are scheduled in the same monitoring occasion, T-DAI is all indicated as 4.

In FIGS. 4 and 5, the determination of the HARQ-ACK codebook is performed in a situation in which only one PUCCH containing HARQ-ACK information is transmitted in one slot. This is called mode 1. In an example of a method by which one PUCCH transmission resource is determined in one slot, when PDSCHs scheduled by different DCIs are multiplexed and transmitted to one HARQ-ACK codebook in the same slot, a PUCCH resource selected for transmitting the HARQ-ACK is determined as a PUCCH resource indicated by a PUCCH resource field indicated in DCI last scheduling the PDSCH. That is, a PUCCH resource indicated by the PUCCH resource field indicated in DCI scheduled before the DCI is ignored.

The following description defines a method and apparatuses for determining the HARQ-ACK codebook in a situation in which two or more PUCCHs containing HARQ-ACK information can be transmitted in one slot. This is called mode 2. The UE can operate only in mode 1 (transmit only one HARQ-ACK PUCCH in one slot) or only in mode 2 (transmits one or more HARQ-ACK PUCCHs in one slot). Alternatively, the UE supporting both mode 1 and mode 2 can be configured to operate in only one mode by higher signaling, or mode 1 and mode 2 can be implicitly determined by a DCI format, an RNTI, a DCI specific field value, scrambling, or the like. For example, a PDSCH scheduled in DCI format A and HARQ-ACK information associated therewith are based on mode 1, and a PDSCH scheduled in DCI format B and HARQ-ACK information associated therewith are based on mode 2.

Whether the HARQ-ACK codebook is the semi-static HARQ-ACK codebook in FIG. 4 or the dynamic HARQ-ACK codebook in FIG. 5 is determined by an RRC signal.

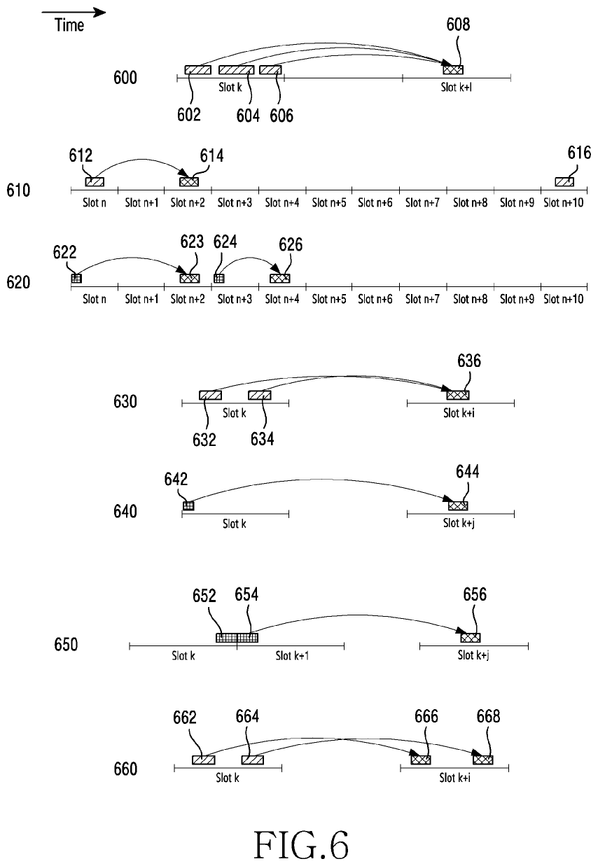

FIG. 6 illustrates an HARQ-ACK transmission process for DL SPS according to an mbodiment of the present disclosure.

Reference numeral 600 of FIG. 6 shows a situation in which a maximum of PDSCHs 602, 604, and 606 which can be received are mapped while time resources do not overlap in slot k. For example, when the PDSCH-to-HARQ feedback timing indicator is not included in a DCI format for scheduling the PDSCH, the UE transmits HARQ-ACK information 608 in slot k+1 according to the value of 1 configured through higher-layer signaling. Accordingly, the size of a semi-static HARQ-ACK codebook of slot k+1 is the same as the maximum number of PDSCHs which can be transmitted in slot k, which is 3. Further, when HARQ-ACK information for each PDSCH is 1 bit, the HARQ-ACK codebook of reference numeral 608 may include a total of 3 bits of [X, Y, Z] in reference numeral 600 of FIG. 6, and X is HARQ-ACK information for the PDSCH 602, Y is HARQ-ACK information for the PDSCH 604, and Z is HARQ-ACK information for the PDSCH 606. When the PDSCH is successfully received, the corresponding information may be mapped to ACK, and otherwise, mapped to NACK. Further, when DCI does not actually schedule the corresponding PDSCH, the UE reports NACK. Specifically, the location of the HARQ-ACK codebook may vary depending on an SLIV of the PDSCH which can be scheduled by the DCI, and may be determined by [Table 9], [pseudo code 1], or [pseudo code 2]. Reference numeral 610 of FIG. 6 shows HARQ-ACK transmission in a situation in which DL SPS is activated. In Rel-15 NR, a minimum period of DL SPS is 10 ms and the length of one slot is 1 ms in subcarrier spacing of 15 kHz in reference numeral 610, and thus the SPS PDSCH 612 is transmitted in slot n and the SPS PDSCH 616 is transmitted in the following slot n+10.

Through the HARQ-ACK information for the SPS PDSCH, an SPS period, HARQ-ACK transmission resource information, an MCS table configuration, and the number of HARQ processes are informed by a higher signal, and then frequency resources, time resources, an MCS value, and the like are informed according to information included in a DCI format indicating the corresponding SPS activation. For reference, PUCCH resources for transmitting HARQ-ACK information may also be configured by a higher signal, and PUCCH resources have the following attributes:
The existence or nonexistence of hopping; and/or
PUCCH format start symbol, symbol length, and the like).

Here, the MCS table configuration and the HARQ-ACK transmission resource information may not exist. When the HARQ-ACK transmission resource information exist, a PUCCH format 0 or 1 in which transmission up to 2 bits can be performed is supported in Rel-15 NR. However, a PUCCH format 2, 3, or 4 larger than or equal to 2 bits can be sufficiently supported in the release thereafter.

Since the HARQ-ACK transmission resource information is included in the DL SPS higher signal configuration, the UE can ignore a PUCCH resource indicator in the DCI format indicating DL SPS activation. Alternatively, the PUCCH resource indicator field may not exist in the corresponding DCI format. On the other hand, when there is HARQ-ACK transmission resource information on the DL SPS higher signal configuration, the UE transmits HARQ-ACK information corresponding to DL SPS through PUCCH resources determined by the PUCCH resource indicator of the DCI format for activating DL SPS. Further, difference between the slot for transmitting the SPS PDSCH and the slot for transmitting the corresponding HARQ-ACK information is determined by a value indicated by the PDSCH-to-HARQ-ACK feedback timing indicator of the DCI format for activating DL SPS or, when there is no indicator, a specific value configured in advance by a higher signal is used. For example, when the PDSCH-to-HARQ-ACK feedback timing indicator is 2 as indicated by reference numeral 610 of FIG. 6, HARQ-ACK information for the SPS PDSCH 612 transmitted in slot n is transmitted through the PUCCH 614 of slot n+2. Further, the PUCCH for transmitting the corresponding HARQ-ACK information may be configured by a higher signal, or the corresponding resource may be determined by an L1 signal indicating DL SPS activation. When it is assumed that a maximum of three PDSCHs can be received as indicated by reference numeral 600 of FIG. 6 and time resources of the PDSCH 612 are the same as those of the PDSCH 604, the location of the HARQ-ACK codebook for the SPS PDSCH 612 transmitted by the PUCCH 612 corresponds to Y in [X Y Z].

When DCI indicating DL SPS release is transmitted, the UE may transmit HARQ-ACK information for the corresponding DCI to the BS. However, in the case of a semi-static HARQ-ACK codebook, the size and the location of the HARQ-ACK codebook are determined by the time resource area to which the PDSCH is allocated and a slot interval (PDSCH to HARQ-ACK feedback timing) between the PDSCH and the HARQ-ACK indicated by an L1 signal or a higher signal as described above. Therefore, when the DCI indicating DL SPS release is transmitted to the semi-static HARQ-ACK codebook, a specific rule is needed instead of randomly determining the location within the HARQ-ACK codebook, and the location of the HARQ-ACK information for DCI indicating DL SPS release is mapped to be the same as the transmission resource area of the corresponding DL SPS PDSCH in Rel-15 NR. For example, reference numeral 620 of FIG. 6 shows a situation in which DCI 622 indicating release of the activated DL SPS PDSCH is transmitted in slot n. When the PDSCH-to-HARQ-ACK feedback timing indicator included in the format of the corresponding DCI 622 indicates 2, HARQ-ACK information for the corresponding DCI 622 is transmitted through the PUCCH 623 of slot n+2 and the UE maps HARQ-ACK information for the DCI 622 indicating DL SPS release to the location of the HARQ-ACK codebook corresponding to the corresponding SPS PDSCH and transmits the same on the basis of the assumption that the pre-configured SPS PDSCH is scheduled in slot n. In connection with this, two methods below are possible, and the BS and the UE transmit and receive the corresponding DCI by the standard or a BS configuration through one method.
Method 6-1-1: transmits DCI indicting DL SPS release only in a slot in which a preconfigured SPS PDSCH is transmitted.

For example, when the SPS PDSCH is configured to be transmitted in slot n as indicated by reference numeral 620 of FIG. 6, the UE transmits the DCI 622 indicating SPS PDSCH release only in slot n and the location of a slot for transmitting HARQ-ACK information therefor is the same as the location of the slot determined on the basis of the assumption that the SPS PDSCH is transmitted. In other words, when the slot for transmitting HARQ-ACK information for the SPS PDSCH is n+2, the slot for transmitting HARQ-ACK information for DCI indicating DL SPS PDSCH release is also n+2.
Method 6-1-2: transmits DCI indicating DL SPS release in a random slot regardless of the slot for transmitting the SPS PDSCH.

For example, when the SPS PDSCH is transmitted in slots n, n+10, n+20 . . . as indicated by reference numeral 620 of FIG. 6, the BS transmits the DCI 624 indicating the corresponding DL SPS PDSCH release in slot n+3 and, when a value indicated by the PDSCH-to-HARQ-ACK feedback timing indicator included in the corresponding DCI is 1 or there is no corresponding field and a pre-configured value by a higher signal is 1, HARQ-ACK information 626 for the DCI indicating DL SPS PDSCH release is transmitted and received in slot n+4.

A minimum period of DL SPS may become shorter than 10 ms. For example, when there is data wirelessly requiring high reliability and low latency and a transmission period of the corresponding data is regular and the period itself is short, different equipments in a factory may have a shorter period than the current period of 10 ms. Accordingly, a DL SPS transmission period may be determined in units of slots, symbols, or symbol groups rather than in units of ms regardless of subcarrier spacing. For reference, a minimum transmission period of the uplink configured grant PUSCH resource is two symbols.

Reference numeral 630 of FIG. 6 shows a situation in which a DL SPS transmission period is 7 symbols smaller than a slot. Since the transmission period is within one slot, a maximum of two SPS PDSCHs 632 and 634 can be transmitted in slot k. When there is no value indicated by the PDSCH-to-HARQ-ACK feedback timing indicator included in DCI indicating SPS activation or no corresponding field, HARQ-ACK information corresponding to the SPS PDSCH 632 and the SPS PDSCH 634 is transmitted in a slot according to a value configured in advance by a higher signal. For example, when the corresponding value is i, the UE transmits HARQ-ACK information 636 for the SPS PDSCH 632 and the SPS PDSCH 634 in slot k+1. For the location of the HARQ-ACK codebook included in the HARQ-ACK information, not only the TDRA which is time resource information for scheduling the SPS PDSCH but also the transmission period may be considered. Since only one SPS PDSCH could be conventionally transmitted per slot, the HARQ-ACK codebook location was determined on the basis of the TDRA which is time resource information without considering the transmission period, but when the DL SPS transmission period is smaller than a slot, both the TDRA which is time resource information and the transmission period may be considered to determine the HARQ-ACK codebook location. The TDRA is time domain resource allocation, and includes a transmission start symbol of the SPS PDSCH and length information. For example, when the DL SPS transmission period is 7 symbols, the start symbol of the DL SPS PDSCH determined by the TDRA is 2, and the length is 3, two DL SPS PDSCHs exist in one slot as indicated by reference numeral 630 of FIG. 6. That is, the first SPS PDSCH 632 is a PDSCH having OFDM symbol indexes 2, 3,and 4 determined by TDRA, and the second SPS PDSCH 634 is a PDSCH having OFDM symbol indexes 9, 10, and 11 considering the TDRA and the transmission period of 7 symbols. That is, the second SPS PDSCH within a slot has the same length as the first SPS PDSCH, but has an offset moving by the transmission period. In summary, in generation or determination of the semi-static HARQ-ACK codebook, the UE uses time resource allocation information to determine the location of the HARQ-ACK codebook for the SPS PDSCH within one slot when the SPS PDSCH transmission period is larger than one slot, and considers both the time resource allocation information and the SSP PDSCH transmission period when the SPS PDSCH transmission period is smaller than one slot.

When the SPS PDSCH transmission period is smaller than one slot, the SPS PDSCH may exist over the slot boundary according to a combination of the transmission period and the TDRA. Reference numeral 650 of FIG. 6 shows the corresponding example in which case the BS configures one SPS PDSCH beyond the slot boundary to repeatedly transmitted while being divided into a PDSCH 652 and a PDSCH 654. At this time, the PDSCH 652 and the PDSCH 654 can always have the same length or can have different lengths. Further, only one piece of the HARQ-ACK information 656 for SPS PDSCHs including the PDSCH 652 and the PDSCH 654 is transmitted by the UE, and a slot which is the corresponding reference is based on slot k+1 repeatedly transmitted in the PDSCH 654.

In the disclosure, the UE does not expect reception of a configuration or an indication of DL SPS PDSCH time resource information beyond the DL SPS transmission period and, when receiving the corresponding configuration or indication, considers the configuration or the indication as an error and ignores the same.

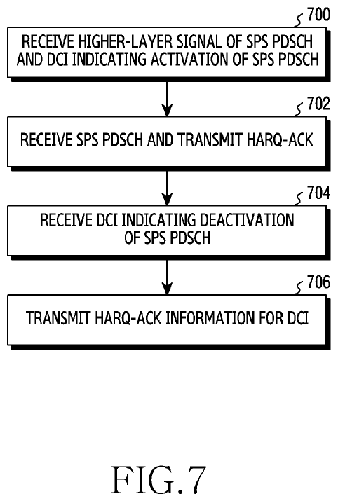

FIG. 7 illustrates a process in which the UE transmits semi-static HARQ-ACK codebook-based HARQ-ACK information for DCI indicating SPS PDSCH deactivation according to an mbodiment of the present disclosure.

The UE receives SPS PDSCH configuration information by a higher signal. At this time, information configured by the higher signal may include a transmission period, an MCS table, HARQ-ACK configuration information, and the like. After receiving the higher-layer signal, the UE receives DCI for activating the SPS PDSCH from the BS in operation 700. After receiving the DCI indicating activation, the UE periodically receives the SPS PDSCH and transmits HARQ-ACK information corresponding thereto in operation 702. Thereafter, when there is no downlink data to be periodically transmitted and received any more, the BS transmits DCI indicating SPS PDSCH deactivation to the UE and the UE receives the same in operation 704. The UE transmits HARQ-ACK information for the DCI indicating SPS PDSCH deactivation according to an SPS PDSCH transmission period in operation 706. For example, when the transmission period is larger than one slot, the UE inserts HARQ-ACK information for DCI indicating SPS PDSCH deactivation into the HARQ-ACK codebook location for HARQ-ACK information corresponding to the SPS PDSCH and transmits the same. The HARQ-ACK information can be transmitted by at least one of method 6-1-1 or method 6-1-2 described with reference to FIG. 6 When the transmission period is smaller than one slot, the UE may transmit HARQ-ACK information for DCI indicating SPS PDSCH deactivation by at least one of method 6-2-1 to method 6-2-5. The description made with reference to FIG. 7 corresponds to an operation applied to the case in which the UE receives a configuration of a semi-static HARQ-ACK codebook in advance from the BS by a higher signal. Further, the description made with reference to FIG. 7 can be applied to only the case in which the UE receives a configuration in advance such that only one HARQ-ACK is transmitted per slot by a higher signal, standard, or UE capability.

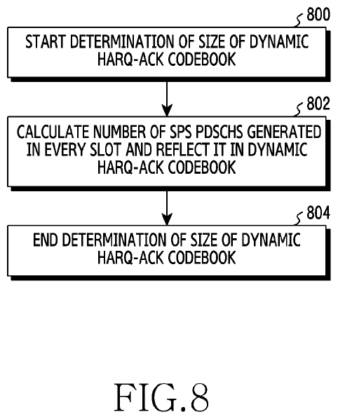

FIG. 8 illustrates a method by which the UE determines a dynamic HARQ-ACK codebook for SPS PDSCH reception according to an embodiment of the present disclosure.

When the UE receives a configuration in advance to operate on the basis of the dynamic HARQ-ACK codebook by a higher signal, the UE starts determining the size of the HARQ-ACK codebook for HARQ-ACK information to be transmitted in a specific slot in operation 800. The UE not only determines the size of the HARQ-ACK codebook for the dynamically scheduled PDSCH but also calculates a total number of SPS PDSCHs generated in the slot corresponding to the slot to transmit HARQ-ACK information, and reflects the same in the size of the HARQ-ACK codebook in operation 802. The UE can configure the dynamic HARQ-ACK codebook by at least one of [pseudo-code 3] or [pseudo-code 4] described with reference to FIG. 6. Thereafter, the UE ends determining of the size of the HARQ-ACK codebook in operation 804 and transmits the HARQ-ACK information in the corresponding slot. Further, the description made with reference to FIG. 8 can be applied to only the case in which the UE receives a configuration In advance such that only one HARQ-ACK is transmitted per slot by a higher signal, standard, or UE capability. For reference, when one SPS PDSCH is repeatedly transmitted over the slot boundary as indicated by reference numeral 650 of FIG. 6, the UE determines the size of the HARQ-ACK codebook on the basis of a slot in which the SPS PDSCH is lately repeatedly transmitted to determine the dynamic HARQ-ACK codebook. Specifically, in the case of slot k, the SPS PDSCH 652 is transmitted as indicated by reference numeral 650 of FIG. 6, but the UE determines the size of the dynamic HARQ-ACK codebook for the SPS PDSCH 654 transmitted in slot k+1 instead of not calculating the number of effective SPS PDSCHs to determine the size of the dynamic HARQ-ACK codebook. Further, when the number (k) of SPS PDSCHs per slot is determined for determination of the size of the dynamic HARQ-ACK codebook in a specific slot in [pseudo-code 4], the number of valid SPS PDSCHs is calculated by a slot (or an end slot) to which an end symbol of the last SPS PDSCH of the repeatedly transmitted SPS PDSCHs belongs.

Periodic data transmission and reception mean the operation of transmitting and receiving data on a predetermined period as described above. The period may have a slot unit, a symbol unit, a frame unit, or a subframe unit, and a value of the period may be generally a natural number but may be an integer (or a rational number) according to a specific situation. In the case of the period having a value of a natural number, the period is 2 symbols, 1 slot, 10 ms, or the like. In the case of the period having a value of an integer (or a rational number), the period is specifically a positive integer (or rational number), and corresponds to 2.1 symbols, 1.4 slots, 10.3 ms, or the like. An example of a situation in which a period having a value of a positive integer is needed may correspond to a data transmission and reception period for media information such as 60 frames per second (fps) or 120 fps. 60 fps means that 60 pieces of frame information are periodically transmitted and received per second, and has a value of 16.66666 . . . ms as a rational value when the value is converted to ms and has a value of 16.67 ms as an integer when the value is rounded to three decimal places. 120 fps means that 120 pieces of frame information are periodically transmitted and received per second, and has a value of 8.33333 . . . ms as a rational value when the value is converted to ms and has a value of 8.33 ms as an integer when the value is rounded to three decimal places. Accordingly, 60 fps or 120 fps needs the periods shown in [Table 12] below, based on the frame structure defined in the 5G NR.

TABLE 12

| | 1 slot | 1 symbol | 1000/60/1 | 1000/120/1 |
|---|---|---|---|---|
| SCS | (ms) | (ms) | symbol | symbol |
| 15 | 1 | 0.071428571 | 233.33 | 116.67 |
| 30 | 0.5 | 0.035714286 | 6533.33 | 3266.67 |
| 60 | 0.25 | 0.017857143 | 365866.67 | 182933.33 |
| 120 | 0.125 | 0.008928571 | 40977066 . . . | 20488533 . . . |
| 240 | 0.0625 | 0.004464286 | 9.18E+09 . . . | 4.59E+09 . . . |

In the case of 120 kHz and 240 kHz, the values are large, so they are not expressed accurately to decimal places in [Table 12], but all of them need periods having a decimal value in units of symbols. However, introducing a new symbol or slot structure to support traffic periods of corresponding 60 fps or 120 fps may change the existing structure of 5G NR or influence other functions, and thus another method based on the exiting 5G NR structure may be needed. In the following description, methods therefor are described in detail. Further, in the following description, the DL SPS is mainly described, but the same application can be made to the UL CG.

In period data transmission, both the DL SPS and the UL CG do not have a dynamic signal such as DCI, so that HARQ ID allocation may be determined in advance. Accordingly, when the BS instructs retransmission of periodic data transmission through a dynamic signal, the UE may determine data for which the retransmission is requested through an HARQ ID. The DL SPS can determine the HARQ ID according to [Equation 1] below.

$$HARQ Process ID = [ floor ( CURRNT\_slot \times 10 \text{} / ( numberOfSlotsPerFrame \times periodicity ) ) ] modulo nrofHARQ - Processes + harq - ProcID - Offset . \qquad [ Equation 1 ]$$

In [Equation 1] above, CURRENT_slot=[(SFN×numberOfSlotsPerFrame)+slot number in the frame, and the SFN is the abbreviation of system frame number, indicates a frame index, and has the length of 10 ms. numberOfSlotsPerFrame is the number of slots included in one frame. numberOfSlotsPerFrame has different numbers of slots depending on subcarrier spacing, and numberOfSlotsPerFrame=10*2a. a has a different value depending on subcarrier spacing, and has the relationship like a=0 in the case of 15 kHz, a=1 in the case of 30 kHz, a=2 in the case of 60 kHz, a=3 in the case of 120 kHz, 1=4 in the case of 240 kHz, a=5 in the case of 480 kHz, and a=6 in the case of 960 kHz. The slot number in the frame is a slot index to which DL SPS resources are allocated within the frame. The periodicity is a transmission and reception period between successive DL SPS resources, and can be configured as one value among 1 to 5120 slots. harq-ProcID-Offset can be or cannot be configured. When harq-ProcID-Offset is configured, it has one value between 0 and nrofHARQ-Processes. The value of nrofHARQ-Processes can be maximally configured as 16 or 32. CURRENT_slot means a slot index to which first transmission resources are allocated among DL SPS-bundled resources. nrofHARQ-Processes may be applied to limit the range of HARQ process numbers used by the DL SPS. When a plurality of DL SPSs use the HARQ process number between resources, overlapping or collision may be generated, and thus harq-ProcID-Offset may be applied to use the range of different HARQ process numbers.

The UL CG can determine the HARQ ID according to [Equation 2] below.

$$HARQ Process ID = [ floor ( CURRNT\_symbol / periodicity ) ] modulo nrofHARQ - Processes + harq - ProcID - Offset 2 . \qquad [ Equation 2 ]$$

In [Equation 2] above, CURRENT_symbol=(SFN×numberOfSlotsPerFrame ×numberOfSymbolsPerSlot+slot number in the frame×numberOfSymbolsPerSlot+symbol number in the slot), and the SFN and numberOfSlotsPerFrame are the same as those described in [Equation 1]. NumberOfSymbolsPerSlot is the number of symbols within the slot, and includes 14 symbols in the case of normal cyclic prefix (NCP) and 12 symbols in the case of extended cyclic prefix (ECP). One of the NCP and the ECP may be configured in advance through a higher-layer signal. The slot number in the frame is a slot number to which UL CG resources within the frame are allocated. The symbol number in the slot is a symbol number of the first UL CG in the slot to which UL CG resources are allocated. The periodicity is a transmission and reception period between successive UL CG resources, and one of 2 symbols to 5120 slots can be configured. harq-ProcID-Offset2 can be or cannot be configured. When harq-ProcID-Offset2 is configured, it has one value between 0 and nrofHARQ-Processes. The value of nrofHARQ-Processes can be maximally configured as 16 or 32. CURRENT_symbol is a symbol index to which first transmission resources are allocated among UL CG-bundled resources. nrofHARQ-Processes may be applied to limit the range of HARQ process numbers used by the UL CG. When the HARQ process number between a plurality of UL CG resources is used, overlapping or collision may be generated, and thus harq-ProcID-Offset2 may be applied to use the range of different HARQ process numbers between a plurality of UL CGs.

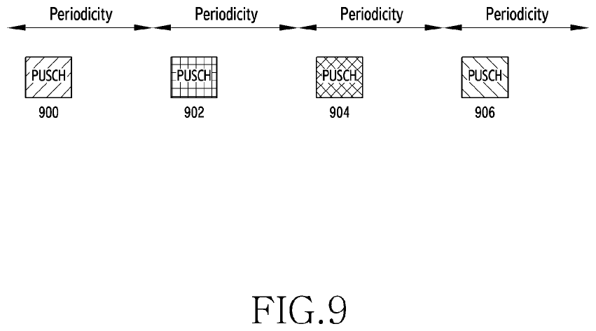

FIG. 9 illustrates periodic uplink data transmission resources according to an embodiment of the present disclosure. PUSCHs 900, 902, 904, and 906 are periodic CG PUSCH resources provided through the one same UL CG configuration. In [Equation 2], when nrofHARQ-Processes is 2 and harq-ProcID-Offset2 is not configured, the HARQ process ID may be 0 in the case of the PUSCH 900, the HARQ process ID may be 1 in the case of the PUSCH 902, the HARQ process ID may be 0 in t″e ca'e of the PUSCH 904, and the HARQ process ID may be 1 in the case of the PUSCH 906. Alternatively, according to the location of CURRENT_symbol of the first PUSCH 900, the HARQ process ID may be 1 in the case of the PUSCH 900, the HARQ process ID may be 0 in the case of the PUSCH 902, the HARQ process ID may be 1 in the case of the PUSCH 904, and the HARQ process ID may be 0 in the case of the PUSCH 906. FIG. 9 is described mainly based on the UL CG, but can be applied to the DL SPS.

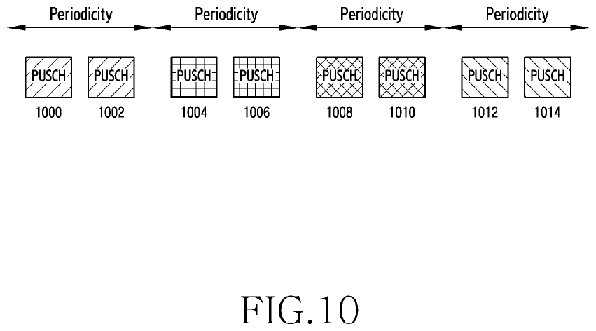

FIG. 10 illustrates periodic uplink data repetitive transmission resources according to an embodiment of the present disclosure. As illustrated in FIG. 9, all of the PUSCHs 1000, 1002, 1004, 1006, 1008, 1010, 1012, and 1014 are periodic CG PUSCU resources provided by one UL CG configuration. However, the PUSCHs 1000 and 1002 are UL CG repetitive transmission configuration resources for the same TB in one period (periodicity), the PUSCH 1004 and 1006 are UL CG repetitive transmission configuration resources for the same TB in one period (periodicity), the PUSCHs 1008 and 1010 are UL CG repetitive transmission configuration resources for the same TB in one period (periodicity), and the PUSCHs 1012 and 1014 are UL CG repetitive transmission configuration resources for the same TB in one period (periodicity). Since “CURRENT_symbol is a symbol index to which the first transmission resource is allocated among UL CG-bundled resources” in [Equation 2], the PUSCH 1000 and the PUSCH 1002 have the same HARQ process ID and the HARQ process ID is determined based on the first symbol of the PUSCH 1000 in FIG. 9. Similarly, in FIG. 9, the PUSCH 1004 and the PUSCH 1006 have the same HARQ process ID and the HARQ process ID is determined based on the first symbol of the PUSCH 1004. Similarly, in FIG. 9, the PUSCH 1008 and the PUSCH 1010 have the same HARQ process ID and the HARQ process ID is determined based on the first symbol of the PUSCH 1008. Similarly, in FIG. 9, the PUSCH 1012 and the PUSCH 1014 have the same HARQ process ID and the HARQ process ID is determined based on the first symbol of the PUSCH 1012.

The parameters in [Equation 1] to [Equation 2] may be values predetermined by a higher layer (RRC or MAC CE).

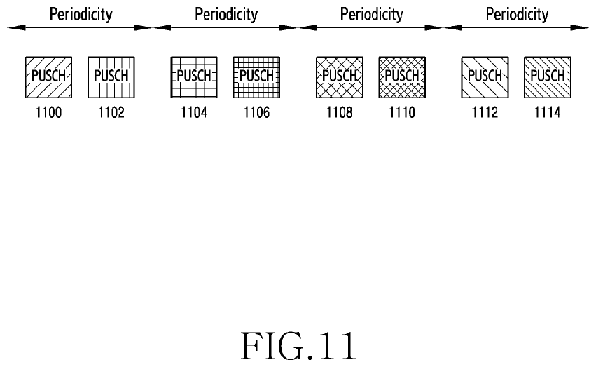

Similar to FIG. 10, FIG. 11 illustrates the case in which a plurality of UL CG resources are configured in one period (periodicity) but different TBs are allocated to different CG PUSCH resources. All of the CG PUSCH resources 1100, 1102, 1104, 1106, 1108, 1110, 1112, and 1114 are resources provided by one CG PUSCH configuration but through which different TBs are transmitted and received. Particularly, the PUSCHs 1100 and 1102 which are resources existing within the same periodicity are resources through which different TBs are transmitted and received. Similarly, the PUSCHs 1104 and 1106 which are resources existing within the same periodicity are resources through which different TBs are transmitted and received. Similarly, the PUSCHs 1108 and 1110 which are resources existing within the same periodicity are resources through which different TBs are transmitted and received. Similarly, the PUSCHs 1112 and 1114 which are resources existing within the same periodicity are resources through which different TBs are transmitted and received. This may be a plurality of periodic CG PUSCH transmissions. For example, in FIG. 11, the CG PUSCH 1100 and the CG PUSCH 1102 may have the same or different time or frequency resources. Further, they may have different MCS values. In FIG. 11, the CG PUSCHs 1100, 1104, 1108, and 1112 have the same frequency resources and have the same time length in the case of time resources. Further, they have the same MCS value. Similarly, in FIG. 11, the CG PUSCHs 1102, 1106, 1110, and 1114 have the same frequency resources and have the same time length in the case of time resources. Further, they have the same MCS value. In such a situation, when the HARQ process ID is applied through [Equation 2], the CG PUSCH resources 1100 and 1102 may receive allocation of the same HARQ process ID. Similarly, the CG PUSCH resources 1104 and 1106 may receive allocation of the same HARQ process ID. Similarly, the CG PUSCH resources 1108 and 1110 may receive allocation of the same HARQ process ID. Similarly, the CG PUSCH resources 1112 and 1114 may receive allocation of the same HARQ process ID. When the BS receives different TBs from the UE through the CG PUSCH resources 1100 and 1102 since the same HARQ process ID is allocated and successfully receives the TB received through the CG PUSCH resource 1100 but fails in reception of the TB transmitted through the CG PUSCH resource 1102, the BS may make a request for retransmitting the TB which the UE desired to transmit through the CG PUSCH resource 1102 and allocate the HARQ process ID allocated to the CG PUSCH resources 1100 and 1102.

Accordingly, when retransmission is instructed through the corresponding HARQ process ID, the UE cannot identify whether retransmission of the TB transmitted in the CG PUSCH resource 1100 is required or retransmission of the TB transmitted in the PUSCH resource 1102 is required, and thus it may be preferable to transmit the TBs transmitted in both the CG PUSCH resources 1100 and 1102. At this time, the BS can schedule two separate PUSCH resources through one DCI. The operation is possible but the UE unnecessarily retransmit the TB transmitted through the CG PUSCH resource 1100, and thus transmission power is unnecessarily wasted from a UE's point of view and resources are unnecessarily used from a BS's point of view. Accordingly, it is possible to consider various embodiments below in order to solve the problem.

### First Embodiment

A method of calculating the HARQ process ID in consideration of the number of CG PUSCHs configured within one periodicity. For example, it is possible to calculate the HARQ process ID for UL CGs, based on [Equation 3] below.

$$HARQ Process ID = \{ the number of configured PUSCHs in a period \times [ \text{} floor ( CURRNT\_symbol / periodicity ) ] \} modulo rofHARQ - Processes + harq - ProcID - Offset 2. \qquad [ Equation 3 ]$$

Note 1: CURRENT_symbol refers to the symbol index of the first transmission occasion of a bundle of configured uplink grants in a period.

Note 2: For k-th transmission occasion in a period, HARQ process ID is n+k−1 where n is HARQ process ID of the first transmission occasion in the same period.

In [Equation 3], Note 1 describes a method of determining the reference of CURRENT_symbol. Here, CURRENT_symbol is the reference of the first symbol index of the CG PUSCH allocated first in chronological order (or a random symbol index within resources to which the CG PUSCH is allocated) when there are a plurality of CG PUSCHs within one periodicity. Further, Note 2 means a method that describes a method of allocating HARQ process IDs to CG PUSCHs after the CG PUSCH first allocated within one periodicity. When a value of nrofHARQ-Processes is 10 and the HARQ process ID of 0 is allocated to the CG PUSCH 1100 by [Equation 3] above and the notes, a value of “the number of configured PUSCHs in a period” is 2, and thus the HARQ ID of the CG PUSCH 1100 is configured as 0, the HARQ ID of the CG PSUCH 1104 is configured as 2, the HARQ ID of the CG PUSCH 1108 is configured as 4, and the HARQ ID of the CG PUSCH 1112 may be configured as 6. Further, the HARQ ID of the CG PUSCH 1102 has a value of 1 increased from the HARQ ID of the CG PUSCH 1100 by 1, the HARQ ID of the CG PUSCH 1106 has a value of 3 increased from the HARQ ID of the CG PUSCH 1104 by 1, the HARQ ID of the CG PUSCH 1110 has a value of 5 increased from the HARQ ID of the CG PUSCH 1108 by 1, and the HARQ ID of the CG PUSCH 1114 has a value of 7 increased from the HARQ ID of the CG PUSCH 1112 by 1. Here, the value of “the number of configured PUSCHs in a period” is information provided when the UL CG PUSCH is activated and may be determined by an L1 signal or a higher-layer (MAC CE or RRC) signal. When the value of “the number of configured PUSCHs in a period” is not provided or there is no higher-layer signal configured related thereto, the UE can consider to determine the HARQ process ID of the UL CG through [Equation 2]. Further, similar to [Equation 2], harq-ProcID-Offset2 may or may not be configured in [Equation 3].

In [Equation 3], allocation of HARQ process IDs to CG PUSCHs after the first CG PUSCH within each periodicity is described through Note 2. Unlike this, in [Equation 4], a value of k is separately defined, and the corresponding value of k may mean the order of CG PUSCHs within the corresponding periodicity. The rest may be similar to the description of [Equation 2].

$$HARQ Process ID = \{ the number of configured PUSCHs in a period \times [ \text{} floor ( CURRNT\_symbol / periodicity ) ] \} modulo rofHARQ - Processes + harq - ProcID - Offset 2 + ( k - 1 ) . \qquad [ Equation 4 ]$$

To describe the value of k by means of FIG. 11 in [Equation 4], k=1 since each of the CG PUSCHs 1100, 1104, 1108, and 1112 is the first PUSCH within respective periodicity in FIG. 11. Further, since each of the CG PUSCHs 1102, 1106, 1110, and 1114 is a second PUSCH within each periodicity in FIG. 11, k=2. Further, similar to [Equation 2], harq-ProcID-Offset2 may or may not be configured in [Equation 4].

Alternatively, instead of [Equation 4], [Equation 5] or [Equation 6] below can be applied.

$$HARQ Process ID = \{ \{ the number of configured PUSCHs in a period \times [ \text{} floor ( CURRNT\_symbol / periodicity ) ] \} + ( k - 1 ) \} modulo nrofHARQ - Processes + harq - ProcID - Offset 2. \qquad [ Equation 5 ]$$

$$HARQ Process ID = \{ [ \text{} floor ( CURRNT\_symbol / periodicity ) ] + ( k - 1 ) \} modulo nrofHARQ - Processes + harq - ProcID - Offset 2. \qquad [ Equation 6 ]$$

Alternatively, the range of HHRQ process IDs allocated to CG PUSCHs for transmitting different TBs within one periodicity can be different and can be determined by [Equation 7] below.

$$HARQ Process ID = \{ [ \text{} floor ( CURRNT\_symbol / periodicity ) ] modulo nrofHARQ - Processes + harq - ProcID - Offset 2 \} + ( k - 1 ) * nrofHARQ - Processes . \qquad [ Equation 7 ]$$

Note 1: CURRENT_symbol refers to the symbol index of the first transmission occasion of a bundle (or the first bundle) of configured uplink grants in a period.

In [Equation 7], harq-ProcID-Offset2 can be or cannot be configured. For example, when the HARQ process ID of the CG PUSCH 1100 is 0, nrofHARQ-Processes is 4, and harq-ProcID-Offset2 is 0 (or is not configured), the HARQ process ID of the CG PUSCH 1104 is 1, the HARQ process ID of the CG PUSCH 1108 is 2, and the HARQ process ID of the CG PUSCH 1112 is 3. Further, since all of the CG PUSCHs 1102, 1106, 1110, and 1114 are second allocated resources in chronological order within the corresponding periodicity, k=2. Accordingly, the HARQ process ID of the CG PUSCH 1102 is 4, the HARQ process ID of the PUSCH 1106 is 5, the HARQ process ID of the CG PUSCH 1110 is 6, and the HARQ process ID of the CG PUSCH 1114 is 7.

The parameter “the number of configured PUSCHs in a period” described in some of the equations can be replaced with “the number of MAC PDUs (transport blocks) which can be transmitted in a CG periodicity.”

### Second Embodiment

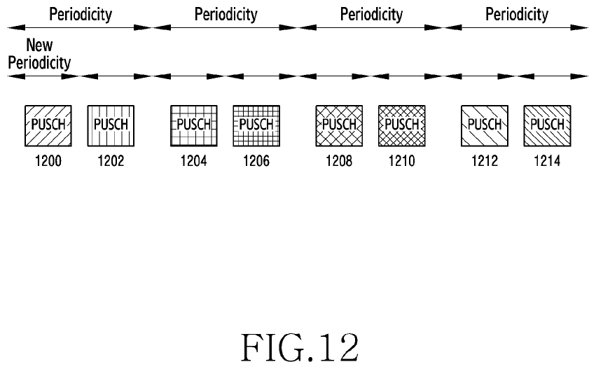

The first embodiment is the method of determining the HARQ process ID in consideration of the number of CG PUSCHs including a plurality of different TBs belonging to one periodicity. Unlike this, a periodicity for determining an HARQ process ID different from the existing periodicity can be introduced. FIG. 12 illustrates a plurality of periodically transmitted CG PUSCH resources according to an embodiment. CG PUSCHs 1200 to 1214 are transmitted and received for respective periodicities, and, similar to FIG. 11, when all of the CG PUSCHs 1200, 1204. 1208, and 1212 have the same frequency resources, they have the same time length and MCS value. Further, when all of the CG PUSCHs 1202, 1206, 1210, and 1214 have the same frequency resources, they have the same time length and MCS value. [Equation 8] below provides a method of determining an HARQ process ID, based on a new periodicity.

$$HARQ Process ID = [ \text{} floor ( CURRNT\_symbol / new periodicity ) ] modulo nrofHARQ - Processes + harq - ProcID - Offset 2. \qquad [ Equation 8 ]$$

Note 1: CURRENT_symbol refers to the symbol index of the first transmission occasion of a bundle of configured uplink grants.

In [Equation 8] above, harq-ProcID-Offset2 can be or cannot be configured. When harq-ProcID-Offset2 is configured, the corresponding value may be one of 0 to 16 (or 32). A value of the new periodicity may be longer or shorter than the periodicity. The value of the new periodicity can be one of common divisors of the periodicity. The value of the new periodicity can be transmitted while being inserted into a higher-layer signal or a DCI signal for activating the UL CG. The new periodicity can have one value or a plurality of values. The case in which the new periodicity has a plurality of values means that, for example, the new periodicity is configured by {4, 4, 4, 2} symbols in a situation in which the periodicity is configured by 14 symbols. That is, 1st/2nd/3rd new periodicity have four symbols, and the last fourth new periodicity has two symbols. A sum of the corresponding new periodicity is 14 symbols and has a value which is the same as the periodicity. For example, in FIG. 12, in a situation in which the periodicity is 2 slots and the new periodicity is 1 slot, nrofHARQ-Processes is 6, harq-ProcID-Offset2 is not configured or is 0 when configured, and when the HARQ process ID of the CG PUSCH 1200 is 0, the HARQ process ID of the CG PUSCH 1202 is 1, the HARQ process ID of the CG PUSCH 1204 is 2, the HARQ process ID of the CG PUSCH 1206 is 3, the HARQ process ID of the CG PUSCH 1208 is 4, the HARQ process ID of the CG PUSCH 1210 is 5, the HARQ process ID of the CG PUSCH 1212 is 0, and the HARQ process ID of the CG PUSCH 1214 is 1. When the BS configures a plurality of CGPUSCH resources including transmission of different TBs within one periodicity, the HARQ process IDs may be allocated in consideration of the new periodicity. Further, the new periodicity which can be configured can have a periodicity shorter than that of FIG. 12, and there can be no CG PUSCH within the corresponding periodicity. Further, there can be a plurality of CG PUSCHs within the corresponding periodicity.

### Third Embodiment

A third embodiment is a method of limiting the number of a plurality of CGPUSCHs which can be configured in one CG periodicity unlike DG PUSCHs. That is, when the maximum number of DG PUSCHs which can be scheduled by one DCI is 8 or 16, CG PUSCHs scheduled by the corresponding DCI are limited to 2 or 4. While a new equation is limited to determine the HARQ process ID in the first embodiment and the second embodiment, the number of CG PUSCHs which can be configured in one UL CG periodicity is limited instead of determining the HARQ process ID through [Equation 2] in the third embodiment. Specifically, for example, [Table 13] shows starting symbol and length indication values (SLIVs) indicating the time resource domain of PUSCHs in fields within DCI. K2 indicates an offset value in units of slots between slots for transmitting and receiving the PDCCH including DCI and slots for transmitting and receiving the PUSCH. The SLIV is the same as the above description of the disclosure. When index 1 is indicated, the UE transmits two different PUSCHs. When index 2 is indicated, the UE transmits three different PUSCHs. When index 3 is indicated, the UE transmits one PUSCH. When index 4 is indicated, the UE transmits four different PUSCHs. When the maximum number of PUSCHs which can be configured in one UL CG periodicity is limited to 2 and is provided by a higher-layer signal or an L1 signal, and the BS indicates activation of the CG PUSCHs through index 2 or 4, the UE can consider that first two PUSCHs are limitingly activated. That is, when index 2 is indicated, the UE can ignore time resource information of the third PUSCH. Alternatively, when index 4 is indicated, the UE can ignore time resource information of the third and fourth PUSCHs. In another embodiment, when an index including the number of PUSCHs larger than 2 is indicated in advance, two PUSCHs used as UL CGs can be determined in advance through a higher-layer signal or an L1 signal.

TABLE 13

| | 1st PUSCHs | 2nd PUSCHs | 3rd PUSCHs | 4th PUSCHs |
|---|---|---|---|---|
| Index | (K2, SLIV) | (K2, SLIV) | (K2, SLIV) | (K2, SLIV) |
| 1 | (1, 10) | (2, 15) | | |
| 2 | (1, 50) | (2, 70) | (3, 5) | |
| 3 | (1, 80) | | | |
| 4 | (1, 1) | (2, 25) | (3, 20) | (4, 20) |

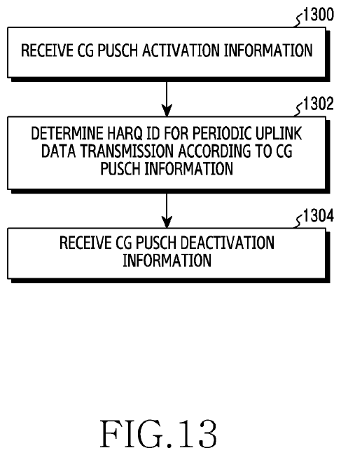

FIG. 13 illustrates a method of determining an HARQ process ID for a CG PUSCH of the UE according to an embodiment of the present disclosure. The UE first receives information on a higher-layer signal related to a CG PUSCH in operation 1300. Activation of the CG PUSCH can be configured (or triggered) by only a higher-layer signal or a combination of the higher-layer signal and an L1 signal. Thereafter, the UE determines an HARQ process ID for each CG PUSCH according to at least one of the first embodiment to the third embodiment or a combination of some thereof in operation 1302. The UE does not perform periodic transmission any more by receiving information of deactivation of the CG PUSCH through the higher-layer signal or the L1 signal.

Although not explicitly illustrated, the BS may operate in accordance with the UE of FIG. 13. For example, the BS may transmit information on the higher-layer signal related to the CG PUSCH to the UE, and activation of the CG PUSCH may be configured (or triggered) by only the higher-layer signal or the combination of the higher-layer signal and the L1 signal. Thereafter, the BS may perform periodic reception, based on the HARQ process ID for each CG PUSCH determined according to at least one of the first embodiment to the third embodiment or the combination of some thereof. The BS may not perform periodic reception any more by transmitting information on deactivation of the CG PUSCH through the higher-layer signal or the L1 signal.

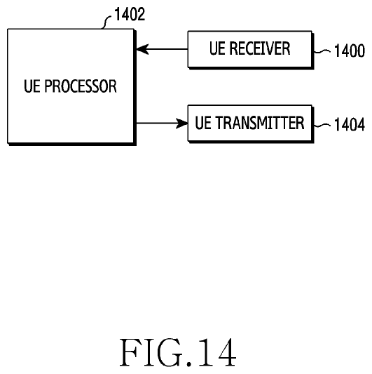

FIG. 14 illustrates a structure of a UE according to embodiments of the present disclosure.

Referring to FIG. 14, the UE of the disclosure may include a UE receiver 1400, a UE transmitter 1404, and a UE processor 1402. The UE receiver 1400 and the UE transmitter 1404 are collectively referred to as a transceiver in an embodiment. The transceiver may transmit and receive a signal to and from the BS. The signal may include control information and data. To this end, the transceiver may include an RF transmitter that up-converts and amplifies the frequency of a transmitted signal, an RF receiver that low-noise amplifies a received signal and down-converts the frequency, and the like. Further, the transceiver may receive a signal through a radio channel, output the signal to the UE processor 1402, and transmit the signal output from the UE processor 1402 through the radio channel. The UE processor 1402 may control a series of processes so that the UE can operate according to the embodiments. Although not explicitly illustrated in FIG. 14, the UE of the disclosure may further include a memory for storing information, data, program, or the like processed inside the UE.

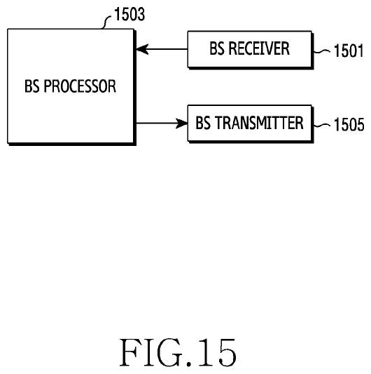

FIG. 15 illustrates a structure of a BS capability according to embodiments of the present disclosure.

Referring to FIG. 15, in an embodiment, the BS may include at least one of a BS receiver 1501, a BS transmitter 1505, and a BS processor 1503. The BS receiver 1501 and the BS transmitter 1505 may be collectively called a transceiver in an embodiment of the disclosure. The transceiver may transmit and receive a signal to/from the UE. The signal may include control information and data. To this end, the transceiver includes an RF transmitter that up-converts and amplifies a frequency of a transmitted signal, an RF receiver that low-noise amplifies a received signal and down-converts the frequency, and the like. Further, the transceiver may receive a signal through a radio channel, output the signal to the UE processor 1503, and transmit the signal output from the UE processor 1503 through a radio channel. The BS processor 1503 may control a series of processes to allow the BS to operate according to the embodiments of the disclosure. Although not explicitly illustrated in FIG. 15, the BS of the disclosure may further include a memory for storing information, data, program, or the like processed inside the BS.

In the drawings in which methods of the disclosure are described, the order of the description does not always correspond to the order in which steps of each method are performed, and the order relationship between the steps may be changed or the steps may be performed in parallel. Alternatively, in the drawings in which methods of the disclosure are described, some elements may be omitted and only some elements may be included therein without departing from the essence of the disclosure.

In the disclosure, the UE operation for the CG PUSCH has been mainly described, but it is sufficiently possible to make the same application to the SPS PDSCH.

In the methods of the disclosure, some or all of the contents included in each embodiment may be performed in combination without departing from the essence of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a plurality of embodiments of the disclosure may be partially combined to operate a base station and a terminal. Moreover, although the above embodiments have been described on the basis of the NR system, other variants based on the technical idea of the embodiments may be implemented in other systems such as FDD and TDD LTE systems.

Furthermore, although exemplary embodiments of the disclosure have been described and shown in the specification and the drawings by using particular terms, they have been used in a general sense merely to easily explain the technical contents of the disclosure and help understanding of the disclosure, and are not intended to limit the scope of the disclosure. It will be apparent to those skilled in the art that, in addition to the embodiments set forth herein, other variants may be achieved on the basis of the technical idea of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a configuration on a configured grant (CG);
identifying a plurality of CG physical uplink shared channels (PUSCHs) within a periodicity based on the configuration;
identifying a plurality of hybrid automatic repeat request (HARQ) process identities (IDs) for the plurality of CG PUSCHs based on an order of a CG PUSCH within the periodicity; and
transmitting, to the base station, the plurality of CG PUSCHs within the periodicity according to the plurality of HARQ process IDs.

2. The method of claim 1, wherein different transport blocks (TBs) are transmitted on the plurality of CG PUSCHs within the periodicity, and
wherein different HARQ process IDs are derived for the plurality of CG PUSCHs within the periodicity.

3. The method of claim 1, wherein, in case that a HARQ process ID offset is not configured, a HARQ process ID for the CG PUSCH is derived according to the following equation:
$$the HARQ process ID = \{ a number of the plurality of CG PUSCHs within the periodicity * floor ( CURRNT\_symbol / the periodicity ) + ( k - 1 ) \} mudulo \{ a number of HARQ processes \} , \qquad [ equation ]$$
and
wherein the CURRENT_symbol is (system frame number*a number of consecutive slots per frame*a number of consecutive symbols per slot+a slot number in the frame*the number of consecutive symbols per slot+a symbol number in the slot), k is the order of the CG PUSCH within the periodicity.

4. The method of claim 3, wherein, in case that the HARQ process ID offset is configured, the HARQ process ID for the CG PUSCH is derived according to the following equation:
$$the HARQ process ID = \{ the number of the plurality of CG PUSCHs within the periodicity * floor ( CURRNT\_symbol / the periodicity ) + ( k - 1 ) \} mudulo \{ the number of HARQ processes + the HARQ process ID offset \} . \qquad [ equation ]$$

5. The method of claim 1, wherein the configuration includes a multi-PUSCH CG.

6. A method performed by a base station in a wireless communication system, the method comprising:
transmitting, to a terminal, a configuration on a configured grant (CG); and
receiving, from the terminal, a plurality of CG physical uplink shared channels (PUSCHs) within a periodicity according to a plurality of hybrid automatic repeat request (HARQ) process identities (IDs) based on the configuration,
wherein the plurality of HARQ process IDs for the plurality of CG PUSCHs are based on an order of a CG PUSCH within the periodicity.

7. The method of claim 6, wherein different transport blocks (TBs) are received on the plurality of CG PUSCHs within the periodicity, and
wherein the plurality of HARQ process IDs for the plurality of CG PUSCHs within the periodicity are different.

8. The method of claim 6, wherein, in case that a HARQ process ID offset is not configured, a HARQ process ID for the CG PUSCH is according to the following equation:
$$the HARQ process ID = \{ a number of the plurality of CG PUSCHs within the periodicity * floor ( CURRNT\_symbol / the periodicity ) + ( k - 1 ) \} mudulo \{ a number of HARQ processes \} , \qquad [ equation ]$$
and
wherein the CURRENT_symbol is (system frame number*a number of consecutive slots per frame*a number of consecutive symbols per slot+a slot number in the frame*the number of consecutive symbols per slot+a symbol number in the slot), k is the order of the CG PUSCH within the periodicity.

9. The method of claim 8, wherein, in case that the HARQ process ID offset is configured, the HARQ process ID for the CG PUSCH is according to the following equation:
$$the HARQ process ID = \{ the number of the plurality of CG PUSCHs within the periodicity * floor ( CURRNT\_symbol / the periodicity ) + ( k - 1 ) \} mudulo \{ the number of HARQ processes + the HARQ process ID offset \} . \qquad [ equation ]$$

10. The method of claim 6, wherein the configuration includes a multi-PUSCH CG.

11. A terminal in a wireless communication system, the terminal comprising:
a transceiver; and
a controller coupled with the transceiver and configured to:
receive, from a base station, a configuration on a configured grant (CG),
identify a plurality of CG physical uplink shared channels (PUSCHs) within a periodicity based on the configuration,
identify a plurality of hybrid automatic repeat request (HARQ) process identities (IDs) for the plurality of CG PUSCHs based on an order of a CG PUSCH within the periodicity, and
transmit, to the base station, the plurality of CG PUSCHs within the periodicity according to the plurality of HARQ process IDs.

12. The terminal of claim 11, wherein different transport blocks (TBs) are transmitted on the plurality of CG PUSCHs within the periodicity, and
wherein different HARQ process IDs are derived for the plurality of CG PUSCHs within the periodicity.

13. The terminal of claim 11, wherein, in case that a HARQ process ID offset is not configured, a HARQ process ID for the CG PUSCH is derived according to the following equation:
$$the HARQ process ID = \{ a number of the plurality of CG PUSCHs within the periodicity * floor ( CURRNT\_symbol / the periodicity ) + ( k - 1 ) \} mudulo \{ a number of HARQ processes \} , \qquad [ equation ]$$
and
wherein the CURRENT_symbol is (system frame number*a number of consecutive slots per frame*a number of consecutive symbols per slot+a slot number in the frame*the number of consecutive symbols per slot+a symbol number in the slot), k is the order of the CG PUSCH within the periodicity.

14. The terminal of claim 13, wherein, in case that the HARQ process ID offset is configured, the HARQ process ID for the CG PUSCH is derived according to the following equation:
$$the HARQ process ID = \{ the number of the plurality of CG PUSCHs within the periodicity * floor ( CURRNT\_symbol / the periodicity ) + ( k - 1 ) \} mudulo \{ the number of HARQ processes + the HARQ process ID offset \} . \qquad [ equation ]$$

15. The terminal of claim 11, wherein the configuration includes a multi-PUSCH CG.

16. A base station in a wireless communication system, the base station comprising:
a transceiver; and
a controller coupled with the transceiver and configured to:
transmit, to a terminal, a configuration on a configured grant (CG), and
receive, from the terminal, a plurality of CG physical uplink shared channels (PUSCHs) within a periodicity according to a plurality of hybrid automatic repeat request (HARQ) process identities (IDs) based on the configuration,
wherein the plurality of HARQ process IDs for the plurality of CG PUSCHs are based on an order of a CG PUSCH within the periodicity.

17. The base station of claim 16, wherein different transport blocks (TBs) are received on the plurality of CG PUSCHs within the periodicity, and
wherein the plurality of HARQ process IDs for the plurality of CG PUSCHs within the periodicity are different.

18. The base station of claim 16, wherein, in case that a HARQ process ID offset is not configured, a HARQ process ID for the CG PUSCH is according to the following equation:
$$the HARQ process ID = \{ a number of the plurality of CG PUSCHs within the periodicity * floor ( CURRNT\_symbol / the periodicity ) + ( k - 1 ) \} mudulo \{ a number of HARQ processes \} , \qquad [ equation ]$$
and
wherein the CURRENT_symbol is (system frame number*a number of consecutive slots per frame*a number of consecutive symbols per slot+a slot number in the frame*the number of consecutive symbols per slot+a symbol number in the slot), k is the order of the CG PUSCH within the periodicity.

19. The base station of claim 18, wherein, in case that the HARQ process ID offset is configured, the HARQ process ID for the CG PUSCH is according to the following equation:
$$the HARQ process ID = \{ the number of the plurality of CG PUSCHs within the periodicity * floor ( CURRNT\_symbol / the periodicity ) + ( k - 1 ) \} mudulo \{ the number of HARQ processes + the HARQ process ID offset \} . \qquad [ equation ]$$

20. The base station of claim 16, wherein the configuration includes a multi-PUSCH CG.
